(19) United States
(12) Patent Application Publication
(10) Pub. No.: US 2008/0091388 A1
(43) Pub. Date: Apr. 17, 2008

(54) Method for calculation radiation doses from acquired image data

(76) Inventors: Gregory A. Failla, Gig Harbor, WA (US); John M. McGhee, Hollis, NH (US); Todd A. Wareing, Gig Harbor, WA (US); Douglas A. Barnett, Patersonville, NY (US)

Correspondence Address: OLYMPIC PATENT WORKS PLLC, P.O. BOX 4277, SEATTLE, WA, 98104, US

(21) Appl. No.: 11/726,386

(22) Filed: Mar. 21, 2007

Related U.S. Application Data
(63) Continuation-in-part of application No. 11/499,862, filed on Aug. 3, 2006.
Application No. 11/499,862 is a continuation-in-part of application No. 11/273,596, filed on Nov. 14, 2005.
Application No. 11/273,596 is a continuation-in-part of application No. 10/910,239, filed on Aug. 2, 2004, now abandoned.
Application No. 10/910,239 is a continuation-in-part of application No. 10/801,506, filed on Mar. 15, 2004, now abandoned.
(60) Provisional application No. 60/454,768, filed on Mar. 14, 2003.
(60) Provisional application No. 60/491,135, filed on Jul. 30, 2003.
(60) Provisional application No. 60/505,643, filed on Sep. 24, 2003.

(51) Int. Cl. G06F 17/10

(52) U.S. Cl. 703/2

(57) ABSTRACT

Various embodiments of the present invention provide processes for applying deterministic radiation transport solution methods for calculating doses and predicting scatter in radiotherapy and imaging applications. One method embodiment of the present invention is a process for using deterministic methods to calculate dose distributions resulting from radiotherapy treatments, diagnostic imaging, or industrial sterilization, and for calculating image scatter for the purposes of image reconstruction. In one embodiment of the present invention, a method provides a means for transport of external radiation sources through field-shaping devices. In another embodiment of the present invention, a method includes a process for calculating the dose response at selected points and volumes prior to radiotherapy treatment planning.

### CROSS-REFERENCE TO RELATED APPLICATIONS

This application is a continuation-in-part of application Ser. No. 11/499,862, filed Aug. 3, 2006, which is a continuation-in-part of application Ser. No. 11/273,596, filed Nov. 14, 2005, which is a continuation-in-part of application Ser. No. 10/910,239, filed Aug. 2, 2004, which is a continuation-in-part of application Ser. No. 10/801,506, filed Mar. 15, 2004, which claims the benefit of provisional Application Nos. 60/454,768, filed Mar. 14, 2003; 60/491,135, filed Jul. 30, 2003; and 60/505,643, filed Sep. 24, 2003.

### TECHNICAL FIELD

The present invention is related to radiation-dose determination and, in particular, computational methods and systems for calculating radiation doses delivered to anatomical tissues and structures from radiotherapy treatments, sterilization processes, or imaging modalities, and for the prediction of scattered radiation related to image reconstruction, for medical and industrial imaging applications.

### BACKGROUND OF THE INVENTION

Radiation transport plays an important role in many aspects of radiotherapy and medical imaging. In radiotherapy, radiation dose distributions are accurately calculated to both the treated regions and neighboring organs and structures where the dose is to be minimized. Dose calculations are commonly used in radiotherapy treatment planning and verification, and are often repeated numerous times in the development and verification of a single patient plan. Some modalities include external beam radiotherapy, brachytherapy, and targeted radionuclide therapies. Multiple variations exist for each of these treatments. For example, photons, electrons, neutrons, protons, and heavy ions can all be delivered through external beams. In addition, many variations exist in beam delivery methods, including 3D conformal radiotherapy (“3D-CRT”), intensity modulated radiotherapy (“IMRT”), and stereotactic radiosurgery (“SRS”). Brachytherapy treatments include photon, electron and neutron sources, and can use a variety of applicators and other delivery mechanisms.

Dose calculations also play a role in medical imaging, where it may be desired to calculate patient doses from radiation delivering imaging modes such as computed tomography (CT), positron emission tomography (PET), and emission computed tomography (ECT) methods, including single-photon emission computed tomography (SPECT). Similarly, dose calculations may also be of benefit to determine local dose distributions for components in industrial sterilization applications.

For industrial and medical imaging, scattered radiation can substantially limit the quality of a reconstructed image. In such cases, accurate computational predictions of the scattered radiation reaching detectors can improve image quality. This is of particular importance in modalities such as volumetric CT imaging (VCT) and SPECT, where the ratio of scattered-to-primary radiation reaching detectors may be relatively high.

The physical models that describe radiation transport through anatomical structures are complex, and accurate methods such as Monte Carlo can be too computationally expensive for effective clinical use. As a result, most clinically employed approaches are based on simplifications which limit their accuracy and/or scope of applicability. For radiotherapy, uncertainties in the delivered dose may translate to suboptimal treatment plans. For imaging, a reduced reconstructed image quality may result.

Radiotherapy treatment planning commonly involves generating a three-dimensional anatomical image through CT or another image modality such as magnetic resonance imaging (MRI). The image data obtained, which is generally in a standard format such as DICOM, are generally reviewed and modified by a physician to identify and segment anatomical regions of interest (treatment planning volume, critical structures, etc.) and to make any additional preparations for radiotherapy treatment planning computations. A medical physicist will then use this data, with physician input, to generate a radiotherapy treatment plan. During treatment plan optimization and verification, radiation dose calculations are carried out on a computer system that may employ shared or distributed memory parallelization and multiple processors.

Methods employed for radiotherapy and imaging radiation-transport computations can be broadly grouped into three categories: Monte Carlo, deterministic, and analytic/empirical. Monte Carlo methods stochastically predict particle transport through media by tracking a statistically significant number of particles. While Monte Carlo methods are recognized as highly accurate, simulations are time consuming, limiting their effectiveness for clinical applications. The phrase “deterministic radiation-transport computation,” in this context, refers to methods which solve the Linear Boltzmann Transport Equation (LBTE), the governing equation of radiation transport, by approximating its derivative terms with discrete volumes. Examples of such approaches include discrete-ordinates, spherical-harmonics, and characteristic methods. Historically, these methods are most well-known in nuclear industry applications, where they have been applied for applications such as radiation shielding and reactor calculations. However, the use of deterministic solvers to radiotherapy and imaging applications has been limited to research in radiotherapy delivery modes such as neutron capture therapy and brachytherapy. This can be attributed to several factors, including methodic limitations in transporting highly collimated radiation sources, and the computational overhead associated with solving equations containing a large number of phase-space variables. The phrase “analytic/empirical radiation-transport computation methods,” in this context, refer to approaches which employ approximate models to simulate radiation transport effects by, for example, using pre-defined Monte Carlo scattering or dose kernels. Examples of analytic/empirical methods include pencil beam convolution (PBC) methods and collapsed cone convolution (CCC). Due to their relative computational efficiency, PBC approaches are widely used in radiotherapy, even though their accuracy is limited, especially in the presence of narrow beams or material heterogeneities. A need exists for accurate, generally applicable and computationally efficient radiation transport methods in radiotherapy and imaging applications.

### SUMMARY OF THE PRESENT INVENTION

One method embodiment of the present invention is a process for using deterministic methods to calculate dose distributions resulting from radiotherapy treatments, diagnostic imaging, or industrial sterilization, and for calculating scatter corrections used for image reconstruction. One embodiment of the present invention provides a means for constructing a deterministic computational grid from an acquired 3-D image representation of an anatomical region, transporting an external radiation source into the anatomical region, calculating the scattered radiation field in the anatomical region, and calculating the dose field in the anatomical region. Another method embodiment of the present invention includes a process which can enable dose responses in an anatomical region to be calculated, prior to treatment planning, independently of treatment parameters, enabling dose fields to be rapidly reconstructed during treatment plan optimization. In another method embodiment of the present invention, a process to compute the scattered radiation reaching detectors external to the anatomical region is provided. In another method embodiment of the present invention, a process for calculating the radiation field exiting the field shaping components of a radiotherapy treatment head is provided.

### BRIEF DESCRIPTION OF THE FIGURES

FIG. 1 shows a photon radiotherapy beam passing through field shaping components and into an anatomical region.

FIG. 2 shows an example of some relevant photon and electron interactions occurring in an anatomical region for external photon beam radiotherapy.

FIG. 3 shows a flow-chart illustrating the calculation process for external photon beam radiotherapy.

FIG. 4 shows focal-point source locations for multiple beams in a radiotherapy treatment.

FIG. 5 shows a ray-tracing-voxel grid for photon beam radiotherapy.

FIG. 6 shows the ray tracing process from multiple focal-source points into the ray-tracing-voxel grid.

FIG. 7 shows ray tracing being performed to every second ray-tracing-grid voxel.

FIG. 8 shows ray tracing being performed at a variable spatial density.

FIG. 9 shows a photon-transport grid for photon beam radiotherapy.

FIG. 10 shows spatial unknowns on a Cartesian element for a tri-linear discontinuous-element representation.

FIG. 11 shows a relationship between ray-tracing-grid voxels and spatial unknowns in a photon-transport grid element.

FIG. 12 shows a photon-transport grid with radiotherapy beams.

FIG. 13 shows an electron-transport grid.

FIG. 14 shows a subset of elements in the electron-transport grid selected for adaptation.

FIG. 15 shows additional elements added for adaptation, surrounding those originally selected for adaptation in FIG. 14.

FIG. 16 shows elements selected for adaptation based on proximity to the radiotherapy beams.

FIG. 17 shows elements selected for adaptation based on proximity to regions of interest.

FIG. 18 shows electron-transport grid elements which are contained in, or overlap, physician contoured regions.

FIG. 19 shows electron-transport grid elements in near proximity to contoured regions.

FIG. 20 shows spatial unknowns on Cartesian elements for two different quadratic finite-element representations.

FIG. 21 shows local element refinement on electron-transport grid elements.

FIG. 22 shows electron-transport grid elements selected for adaptation, and refinement of those elements for a second electron-transport calculation performed only on the refined elements.

FIG. 23 shows brachytherapy sources within a treated region and adjacent regions of interest.

FIG. 24 shows photons emitted from one brachytherapy source being attenuated and scattered through adjacent sources.

FIG. 25 shows ray tracing of the primary photons performed on both the ray-tracing-grid voxels and separate representations of the brachytherapy source geometries.

FIG. 26 shows example intracavitary brachytherapy applicators, shields, and source positions.

FIG. 27 shows ray tracing of the primary photons performed on both the ray-tracing-grid voxels and separate representations of the brachytherapy applicator geometries.

FIG. 28 shows ray tracing to voxels internal to the brachytherapy applicators for calculating the first scattered-photon source in those voxels.

FIG. 29 shows a flow-chart describing the process for pre-calculating dose responses at prescribed locations prior to treatment planning.

FIG. 30 shows an electron-transport grid created in the proximity of a localized adjoint source.

FIG. 31 shows local refinement in the element where an adjoint electron source is located, so that the adjoint source can be represented by a smaller element.

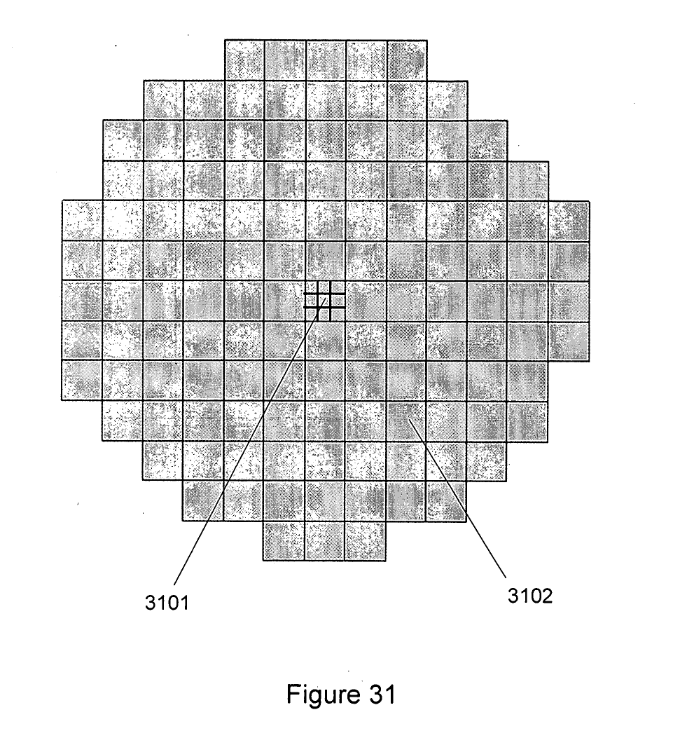

FIG. 32 shows electron-transport grid elements encompassing a region of interest for an adjoint electron-transport calculation.

FIG. 33 shows an example computed tomography beam passing through an anatomical region and out to a detector array.

FIG. 34 shows an example of relevant photon interactions occurring inside an anatomical region for computed tomography imaging.

FIG. 35 shows a flow chart of the calculation process for predicting image scatter in computed tomography.

FIG. 36 shows a ray trace, as part of the last-collided flux method, from a detector point through a computational mesh of the anatomical region to compute the photon scatter reaching that detector point along the direction of the ray.

FIG. 37 shows relevant field shaping components of a linear accelerator, along with examples of photon interactions in the patient-independent field-shaping components.

FIG. 38 shows separate computational meshes constructed on relevant patient-dependent field-shaping components.

FIG. 39 shows a 2-D grid used to score the primary-photon flux exiting the patient-specific field-shaping devices.

FIG. 40 shows photons scattering through patient-dependent field-shaping components, where computational grids are only created in regions where scattered photons have a high probability of passing into the anatomical region.

FIG. 41 shows two locations where the scattered photon field exiting the treatment head may be calculated, either at a plane below the treatment head exit, or at the boundary of the photon-transport grid.

FIG. 42 shows ray tracing, using the last-collided flux method, through the patient-dependent field-shaping components and up to the patient independent extra-focal source, to calculate the scattered photons reaching the plane where the extra focal source is calculated below the treatment head exit.

FIG. 43 shows point sources representing focal and extra focal photon sources.

FIG. 44 shows ray tracing, using the last-collided flux method, through the patient-dependent field-shaping components, and up to the patient independent extra-focal source, to calculate the scattered photons reaching the perimeter of the photon-transport grid.

FIG. 45 shows ray tracing, using the last-collided flux method, up to the patient-independent electron-source plane to calculate electrons from this source plane reaching the perimeter of the electron-transport grid.

FIG. 46 shows a computational grid constructed over the patient-independent field-shaping components to calculate the scattered photon field in the computational grid resulting from multiple scattering events.

### DETAILED DESCRIPTION OF THE INVENTION

1. Dose Calculations for External Photon Beam Radiotherapy

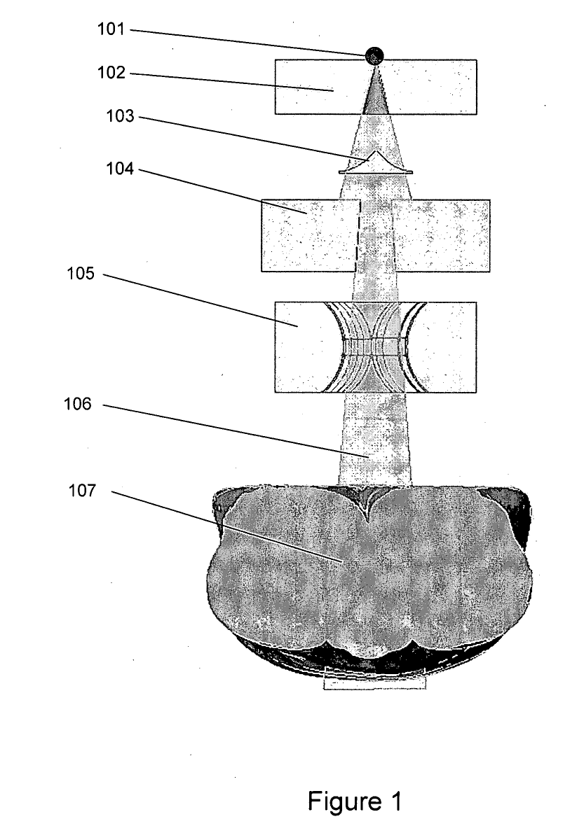

External photon beam radiotherapy encompasses a variety of delivery techniques, including, but not limited to, 3D-CRT, IMRT, and SRS. FIG. 1 shows a photon radiotherapy beam passing through field shaping components and into an anatomical region. In external photon beam radiotherapy, a photon source 101 may be produced through a number of methods, such as an electron beam impinging on a target in a linear accelerator. This photon source may then be collimated through field-shaping devices, such as the primary collimator 102, flattening filter 103, blocks 104, and multi-leaf collimators 105 to create a beam 106 having a desired spatial distribution that is delivered to an anatomical region 107. The radiation beam may be delivered through a rotating gantry, which may move to multiple positions in the course of a single treatment. By delivering beams from multiple locations, each converging on the treatment region, the highest dose can be concentrated on the treatment region. At each gantry position, the field-shaping devices are modified to achieve an optimal spatial distribution. In more advanced modalities, such as intensity modulated radiation therapy (IMRT), multi-leaf collimators may be used to deliver numerous fields at each gantry position, or alternatively produce a continuously varying field profile. By doing this, spatial variations in the beam intensity can be realized, leading to greater dose conformity.

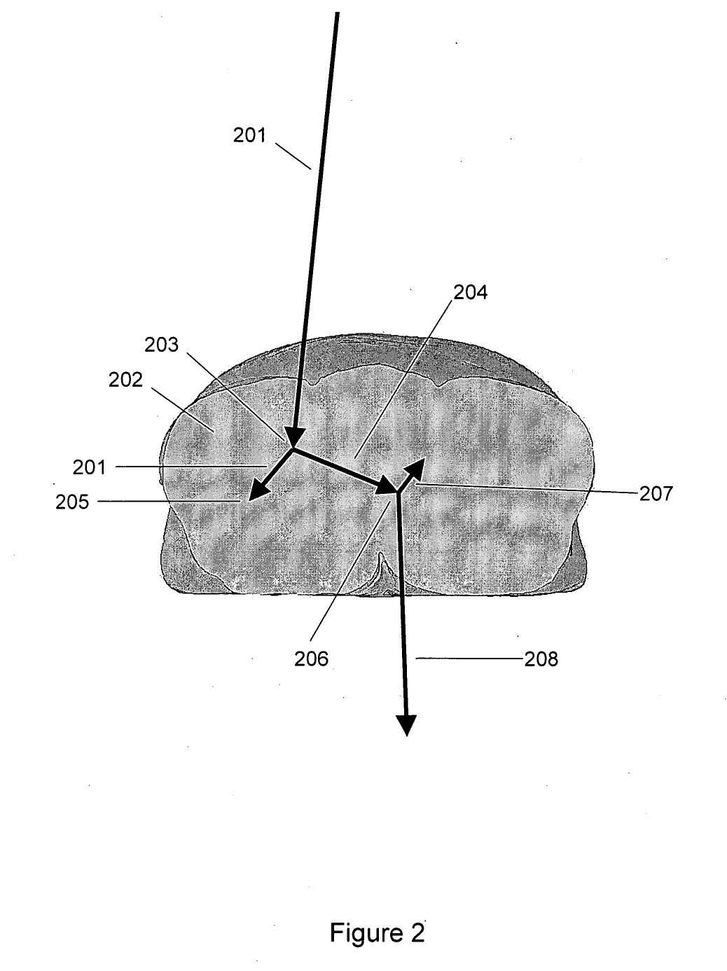

FIG. 2 shows an example of some relevant photon and electron interactions occurring in an anatomical region for external photon beam radiotherapy. As a photon passes into the anatomical region, a variety of particle interactions may occur, such as scattering, absorption, and secondary particle creation. As an example, a photon 201 passes into the anatomical region 202, and a collision occurs 203 which scatters the photon so that it has a new direction of travel and lower energy 204. The collision also produces a free electron that deposits its energy locally 205. The photon goes on to have another collision 206 where an electron is produced that deposits energy locally 207. The twice scattered photon 208 then exits the anatomical region at a lower energy. For photon energies used in external beam radiotherapy, the range of the secondary electrons produced by photon interactions in the anatomical region can be significant. As a result, spatial electron transport generally needs to be modeled.

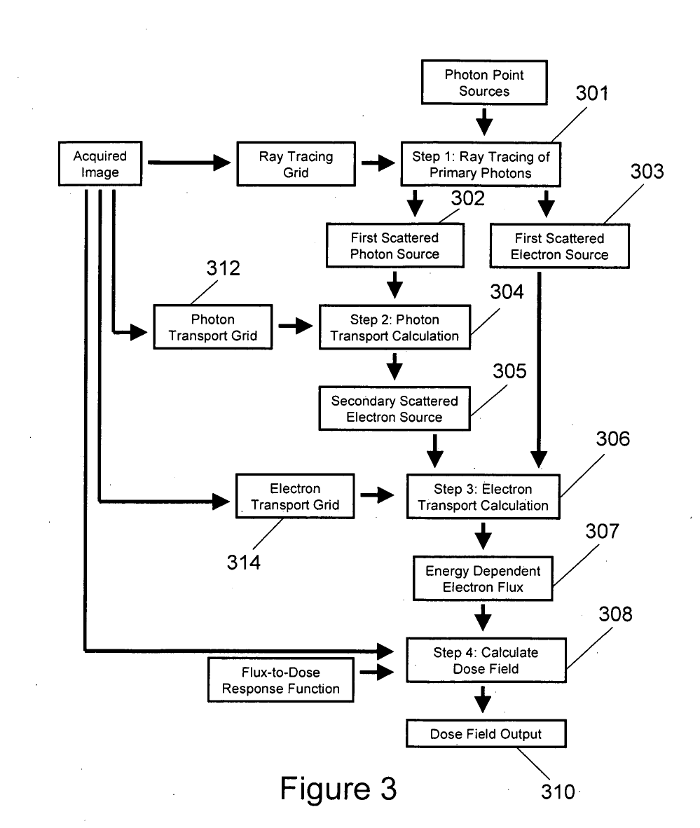

FIG. 3 shows a flow-chart illustrating the calculation process for external photon beam radiotherapy. Inputs to Step (1) 301 include the ray-tracing grid and separate photon point sources for each gantry position, for which the photon energy spectrum and intensity may be anisotropic in angle. A ray-tracing method is used to transport photons from the point sources into a voxel grid that represents the anatomical region. The output from Step (1) includes a first scattered-photon source 202 and a first-scattered-electron source 303 resulting from all point sources. In Step (2) 304, the first scattered-photon source is mapped to a photon-transport grid 312, and a deterministic transport calculation is performed to compute the scattered photon field in the anatomical region resulting from the secondary photon interactions in the anatomical region. The output of Step (2) is a spatially distributed scattered-electron source 305 resulting from the secondary photon interactions. In Step (3) 306, the sources calculated in Steps (1) and (2) are mapped to the electron-transport grid 314, and a deterministic transport calculation is performed to compute the electron flux distribution 307 in the anatomical region. In Step (4) 308, the energy dependent electron flux distribution calculated in Step (3) and a desired electron flux-to-dose response function 309 (dose-to-medium, dose-to-water, etc.) are inputs. Output from Step (4) is the dose field 310 in the anatomical region at a specified spatial resolution and dose response. This process is described in detail in the following sections.

1.1 Transport of External Radiation Sources into the Anatomical Region

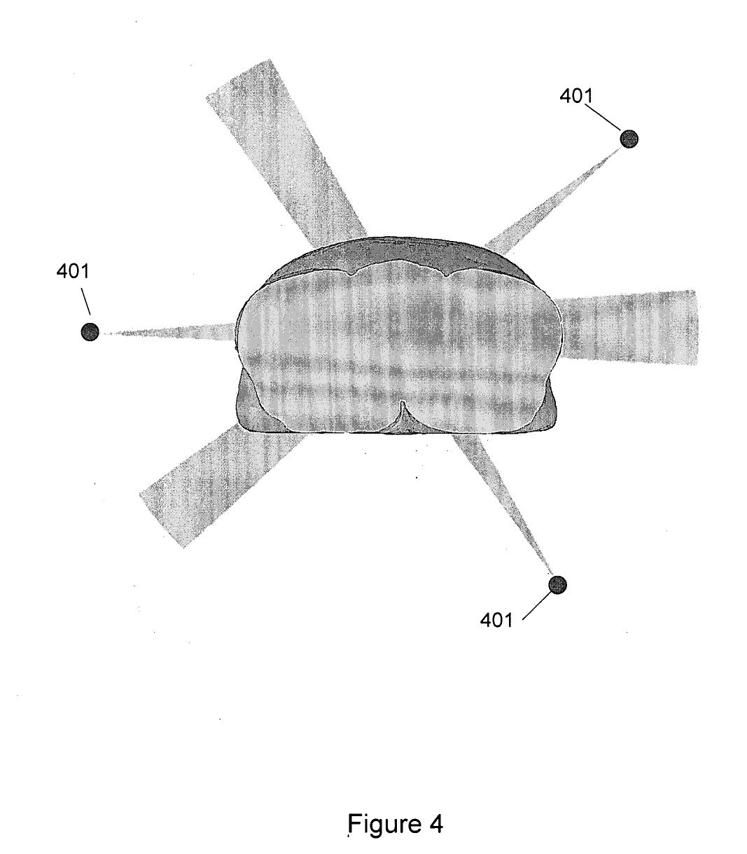

In certain embodiments of the present invention, the photon field exiting the field-shaping devices, referred to as “the primary photon source,” may be represented as a collection of point sources, each of which may be anisotropic in intensity by particle energy. FIG. 4 shows focal-point source locations for multiple beams in a radiotherapy treatment. One point source 401 may generally exist to represent the focal component for each gantry position. For modalities, such as IMRT, where multiple fields are delivered for each gantry position, the point source for that gantry position may represent the integrated sum of all individual fields at that gantry position. Each focal point source may be located at the treatment head focal point for that gantry position, which is generally at the target, where the bremsstrahlung photons are produced from the primary electron beam.

In one embodiment of the present invention, extra-focal scatter may be represented by one or more additional point sources per gantry position, which may be located below the focal source for that gantry position, for example, below the flattening filter. Similarly, the extra-focal point source(s) for that gantry position may represent the integrated sum of all individual fields at that gantry position.

One means to describe the photon point source anisotropy is on a 2-D grid oriented normal to the primary beam direction, at a prescribed distance from the point source. At each location on the 2-D grid, an energy dependent photon flux is prescribed, which represents the photon source exiting the field-shaping devices along the vector defined by the line proceeding from the point source to that location on the 2-D grid.

A 3-D representation of the anatomical region, typically in DICOM format, is used as input. Based on a predefined relationship, image pixel data (for example CT Hounsfield numbers) are converted to material properties, also referred to as cross sections, for radiation transport analysis. Numerous methods exist for converting image data to material properties, which in general can be applied to the current process.

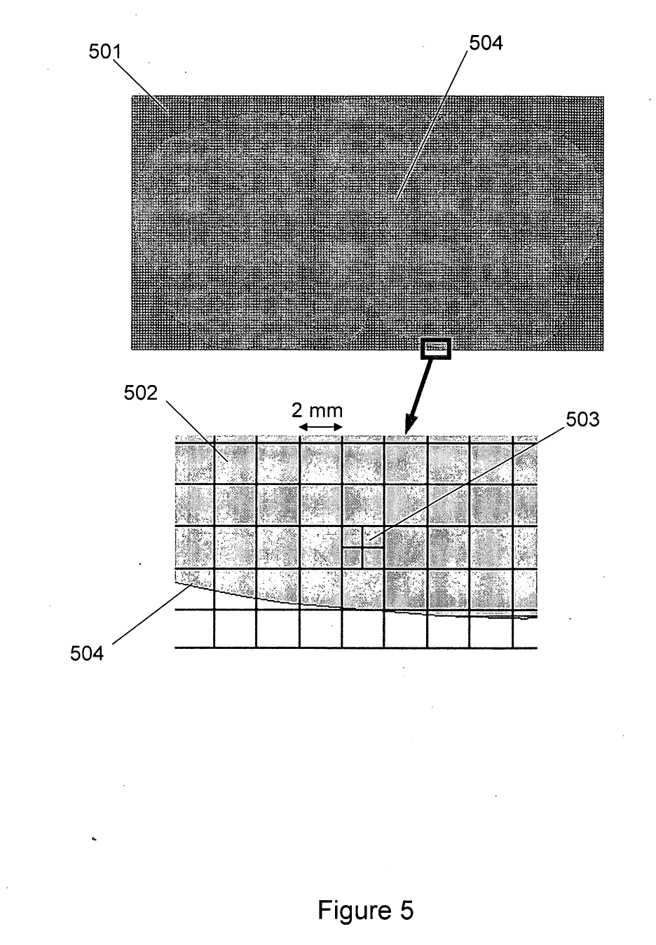

FIG. 5 shows a ray-tracing-voxel grid for photon beam radiotherapy. Ray tracing may be performed on a Cartesian voxel grid of the anatomical region, referred to as the ‘ray-tracing grid’ 501, where ‘voxel’ refers to a region of constant material properties. To balance speed and accuracy, the voxels 502 may be coarser than that of the image pixels 503. For example, for image pixels of 1×1×2 mm³ in size, 2×2×2 mm³ voxels may be used for the ray-tracing grid, and the voxel grid may be aligned such that an integral number of image pixels may be contained in each ray-tracing-grid voxel. The ray-tracing grid extents may be created such that it is based on a bounding box which fully encloses the perimeter of the anatomical region 504.

Each voxel may contain a single homogenized material, obtained by averaging material properties from each image pixel contained within that voxel. For example, the total interaction cross section, σₜ ( r̅), varies with position, but its volume averaged (i.e.: homogenized) value can be expressed as

$${σ}_{t} = \frac{{\int }_{Δ V}^{} ⅆ V {σ}_{t} ( \vec{r} )}{{\int }_{Δ V}^{} ⅆ V} , \qquad ( 1 )$$

where Δ V is the volume over which the material property is to be homogenized.

Each ray trace proceeds from the point source into the ray-tracing grid to calculate the photon and electron first scattered sources in each ray-tracing-grid voxel. In this context, ‘first scattered sources’ refer to the angular and energy dependent photon and electron sources resulting from the first particle collisions in the anatomical region. The methodology for calculating this is described below.

For the application of interest, it is known that the Boltzmann transport equation, BTE, describes the flow of radiation, including photons and electrons, through a medium. We can make addition assumptions to further simplify the system that is to be solved. Primarily, the nature of our problem allows us to solve the steady state form of the BTE.

For a volume, V, with surface, δV, the steady state, three-dimensional linear Boltzmann transport equation (LBTE) for neutral particles, along with vacuum

$$\begin{matrix}\hat{Ω} \cdot \vec{∇} Ψ ( \vec{r} , E , \hat{Ω} ) + {σ}_{t} ( \vec{r} , E ) Ψ ( \vec{r} , E , \hat{Ω} ) = {q}^{scat} ( \vec{r} , E , \hat{Ω} ) + {q}^{ex} ( \vec{r} , E , \hat{Ω} ) , ∀ \vec{r} ∈ V , & ( 2 a ) \\ Ψ ( \vec{r} , E , \hat{Ω} ) = 0 , ∀ \vec{r} ∈ δ V , \hat{Ω} \cdot \vec{n} < 0. & ( 2 b )\end{matrix}$$

Here Ψ(\vec{r}, E, \hat{Ω}) is the angular flux at position \vec{r}=(x, y, z), energy E., direction \hat{Ω}=(μ, η, ξ), and \vec{n} is the normal vector to surface δV. The first term on the left hand side of Equation (2a) is termed the streaming operator. The second term on the left hand side of Equation (2a) is termed the collision or removal operator, where σₜ (\vec{r}, E) is the macroscopic total cross section. The right hand side of Equation (2a) includes the source terms, where q^{scat} (\vec{r}, E, \hat{Ω}) is the scattering source and q^{ex} (\vec{r}, E, \hat{Ω}) is the extraneous, or fixed, source. The vacuum boundary condition shown in Equation (2b) states that no particles are entering the problem domain through the boundary.

For transporting charged particles, like electrons, the energy straggling of the free electrons is treated with a continuous-slowing-down, CSD, operator and uses the Generalized Boltzmann-Fokker-Planck transport equation (GBFPTE). This formulation is discussed below in Section 1.3.

For the LBTE, the scattering source is explicitly given as

$${q}^{scat} ( \vec{r} , E , \vec{Ω} ) = {\int }_{0}^{∞} ⅆ {E}^{′} {\int }_{4 π}^{} {σ}_{s} ( \vec{r} , {E}^{′} \to E , \hat{Ω} \cdot {\hat{Ω}}^{′} ) Ψ ( \vec{r} , {E}^{′} , {\hat{Ω}}^{′} ) ⅆ {\hat{Ω}}^{′} , \qquad ( 3 )$$

where σₛ (\vec{r}, E′→E,\hat{Ω}·\hat{Ω}′) is the macroscopic differential scattering cross section. It is customary to expand the macroscopic differential scattering cross section into Legendre polynomials P₁ (μ₀), where μ₀=\hat{Ω}·\hat{Ω}′. This allows the differential cross section to be expressed as:

$${σ}_{s} ( \vec{r} , {E}^{′} \to E , \hat{Ω} \cdot {\hat{Ω}}^{′} ) = {\sum }_{l = 0}^{∞} \frac{( 2 l + 1 )}{4 π} {σ}_{s , l} ( \vec{r} , {E}^{′} \to E ) {P}_{l} ( {μ}_{0} ) . \qquad ( 4 )$$

It is also customary to expand the angular flux appearing in the scattering source in spherical harmonics:

$$Ψ ( \vec{r} , {E}^{′} , {\hat{Ω}}^{′} ) = {\sum }_{l = 0}^{∞} {\sum }_{m = - l}^{l} {ϕ}_{l}^{m} ( \vec{r} , {E}^{′} ) {Y}_{l}^{m} ( {\hat{Ω}}^{′} ) , \qquad ( 5 )$$

where Y₁^{m} (\hat{Ω}′) are the spherical harmonic functions and φ₁^{m} (r′, E′) are the spherical harmonic moments of the angular flux given by

$${ϕ}_{l}^{m} ( \vec{r} , E ) = {\int }_{4 π}^{} ⅆ {{Ω}^{′} ( {Y}^{*} )}_{l}^{m} Ψ ( \vec{r} , {\hat{Ω}}^{′} , E ) . \qquad ( 6 )$$

Because of practical limitations, a limit is set on the scattering order, 0≦I≦L, and hence the number of spherical harmonic moments kept in the scattering source. The scattering source ultimately becomes

$${q}^{scat} ( \vec{r} , E , \hat{Ω} ) = {\sum }_{l = 0}^{L} \frac{2 l + 1}{4 π} {\sum }_{m = - l}^{l} {\int }_{0}^{∞} ⅆ {E}^{′} {σ}_{s , l} ( \vec{r} , {E}^{′} ) {ϕ}_{l}^{m} ( \vec{r} , {E}^{′} ) {Y}_{l}^{m} ( \hat{Ω} ) . \qquad ( 7 )$$

The multigroup approximation is used by the ray tracing and the deterministic solution methods. This discretization of the energy variable divides the energy continuum into a finite number of energy bins referred to as “energy groups.” The angular flux for energy group g is then expressed as

$${Ψ}_{g} ( \vec{r} , \hat{Ω} ) ≡ {\int }_{{E}_{g}}^{{E}_{g - 1}} ⅆ E Ψ ( \vec{r} , \hat{Ω} , E ) . \qquad ( 8 )$$

Similar expressions can be formulated for the flux moments, the source terms and the material properties so that the LBTE for group g can be expressed as

$$\hat{Ω} \cdot \vec{∇} {Ψ}_{g} ( \vec{r} , \hat{Ω} ) + {σ}_{t , g} ( \vec{r} ) {Ψ}_{g} ( \vec{r} , \hat{Ω} ) = {q}_{g}^{scat} ( \vec{r} , \hat{Ω} ) + {q}_{g}^{ex} ( \vec{r} , \hat{Ω} ) , ∀ \vec{r} ∈ V , \\ g = 1 , … G \qquad ( 9 )$$

Thus, a linear system of G equations that are coupled through the scattering source results. For electron transport this set of linearly dependent equations are also coupled by the continuous slowing down operator. Section 1.3 discusses the deterministic electron transport method.

For an isotropic photon point source, q^{p}, located at \vec{r}^{p}, the primary-photon flux can be calculated analytically, as shown below in Equation (10), where the BTE for a single energy group, Ψ(\vec{r}, \hat{Ω})≡Ψ_{g}(\vec{r}, \hat{Ω}), and vacuum boundaries is simplified:

$$\hat{Ω} \cdot \vec{∇} Ψ ( \vec{r} , \hat{Ω} ) + {σ}_{t} ( \vec{r} ) Ψ ( \vec{r} , \hat{Ω} ) = {q}^{scat} ( \vec{r} , \hat{Ω} ) + \frac{{q}^{p}}{4 π} δ ( \vec{r} - {\vec{r}}_{p} ) , \qquad ( 10 )$$

where δ is the Dirac-delta function.

To treat this specific problem, the principal of linear superposition is used to define the total angular flux as the summation of un-collided and collided flux components,
Ψ(\vec{r},\hat{Ω})≡Ψ^{(u)}(\vec{r},\hat{Ω})+Ψ^{(c)}(\vec{r},\hat{Ω}) (11)
Ψ^{(u)} represents the primary or the un-collided photon angular flux and Ψ^{(c)} is the secondary or collided photon angular flux. Breaking the angular flux into two components allows for solving for each component using a unique optimized method.

Substituting Equation (11) into Equation (10) allows the point-source problem to be expressed in terms of collided and un-collided fluxes,

$$\begin{matrix}\hat{Ω} \cdot \vec{∇} {Ψ}^{( u )} ( \vec{r} , \hat{Ω} ) + {σ}_{t} ( \vec{r} ) {Ψ}^{( u )} ( \vec{r} , \hat{Ω} ) = \frac{{q}^{p}}{4 π} δ ( \vec{r} - {\vec{r}}_{p} ) & ( 12 ) \\ \hat{Ω} \cdot \vec{∇} {Ψ}^{( c )} ( \vec{r} , \hat{Ω} ) + {σ}_{t} ( \vec{r} ) {Ψ}^{( c )} ( \vec{r} , \hat{Ω} ) = {q}^{scat , ( c )} ( \vec{r} , \hat{Ω} ) + {q}^{scat , ( u )} ( \vec{r} , \hat{Ω} ) , & ( 13 )\end{matrix}$$

where q^{scat,(u)}(\vec{r}, \hat{Ω}) is the first scattered distributed source and is evaluated using Equations (6) and (7) with Ψ^{(u)}(\vec{r}, \hat{Ω}) from Equation (12).

The equation for the un-collided angular flux may now be solved analytically. Doing so provides the following expression for the un-collided photon angular flux that results from a point emission:

$${Ψ}^{( u )} ( \vec{r} , \hat{Ω} ) = δ ( \hat{Ω} - \frac{\vec{r} - {\vec{r}}_{p}}{\vert \vec{r} - {\vec{r}}_{p} \vert} ) \frac{{q}^{p}}{4 π} \frac{{ⅇ}^{- τ ( \vec{r} , {\vec{r}}_{p} )}}{{\vert \vec{r} - {\vec{r}}_{p} \vert}^{2}} . \qquad ( 14 )$$

Now, from Equation (5), the spherical harmonic moments of this un-collided angular flux become:

$${ϕ}_{l}^{m , ( u )} ( \vec{r} ) = {Y}_{l}^{m} ( \frac{\vec{r} - {\vec{r}}_{p}}{\vert \vec{r} - {\vec{r}}_{p} \vert} ) \frac{{q}^{p}}{4 π} \frac{{ⅇ}^{- τ ( \vec{r} , {\vec{r}}_{p} )}}{{\vert \vec{r} - {\vec{r}}_{p} \vert}^{2}} . \qquad ( 15 )$$

Here τ(\vec{r}, \vec{r}ₚ) is the optical distance between \vec{r} and \vec{r}ₚ.

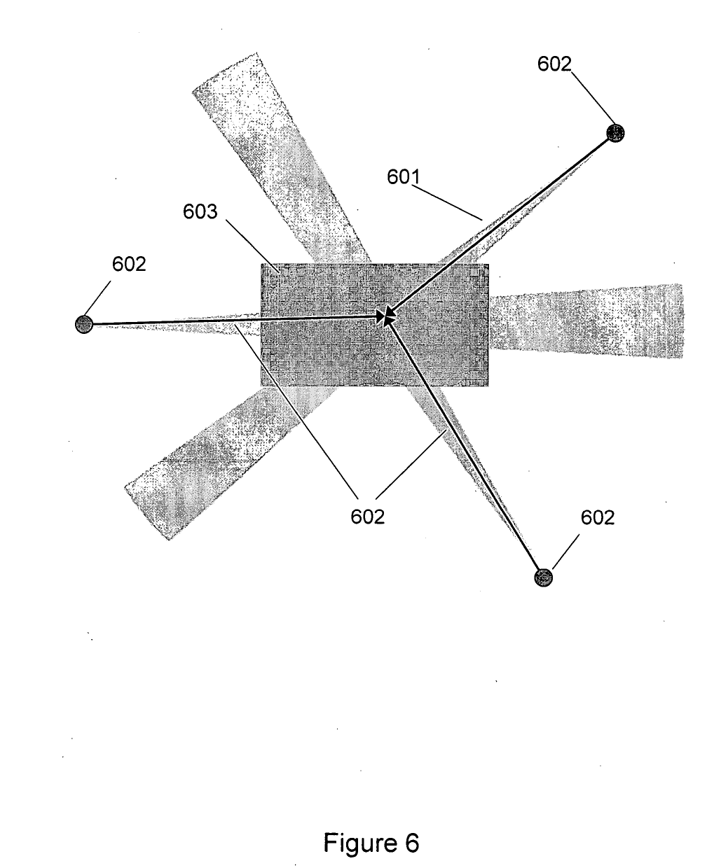

FIG. 6 shows the ray tracing process from multiple focal-source points into the ray-tracing-voxel grid. The angular dependent primary-photon flux may be calculated by ray-tracing 601 from the point sources 602 to the center of voxels in the ray-tracing grid 603. Equation (11) expresses this process mathematically. Ray tracing only needs to be performed along angles where the magnitude of the photon source exceeds a prescribed threshold. Additionally, ray tracing may not be performed to ray-tracing-grid voxels having a density below a user defined threshold, either internal or external to the anatomical region.

As shown by Equation (6), the first scattered photon and first scattered-electron sources in every voxel where the primary-photon flux is computed may be obtained using the particle cross sections, σ_{s,l}(\vec{r}, E′), corresponding to the interaction of interest and the material in that voxel.

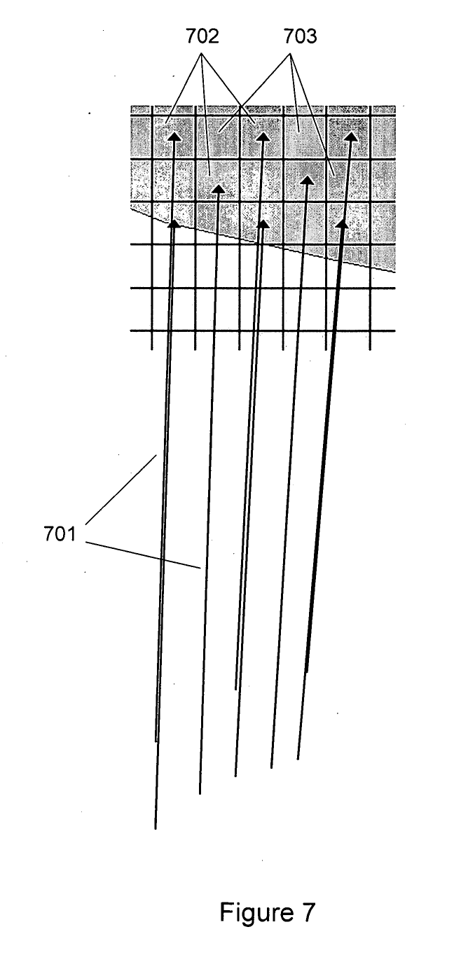

FIG. 7 shows ray tracing being performed to every second ray-tracing-grid voxel. To reduce ray tracing times, the spatial density of the ray tracing may be varied based on gradients in the point source. In angles where the incoming beam intensity and spectrum is relatively invariant, the ray tracing 701 may be performed to the center of every second voxel 702 rather than to every voxel center, and averaging from the neighboring voxels may be performed to compute the primary-photon flux in the remaining voxels 703. However, in regions where the source gradients are large, such as in the beam penumbra, ray tracing may be performed to every voxel center, or at even a finer resolution.

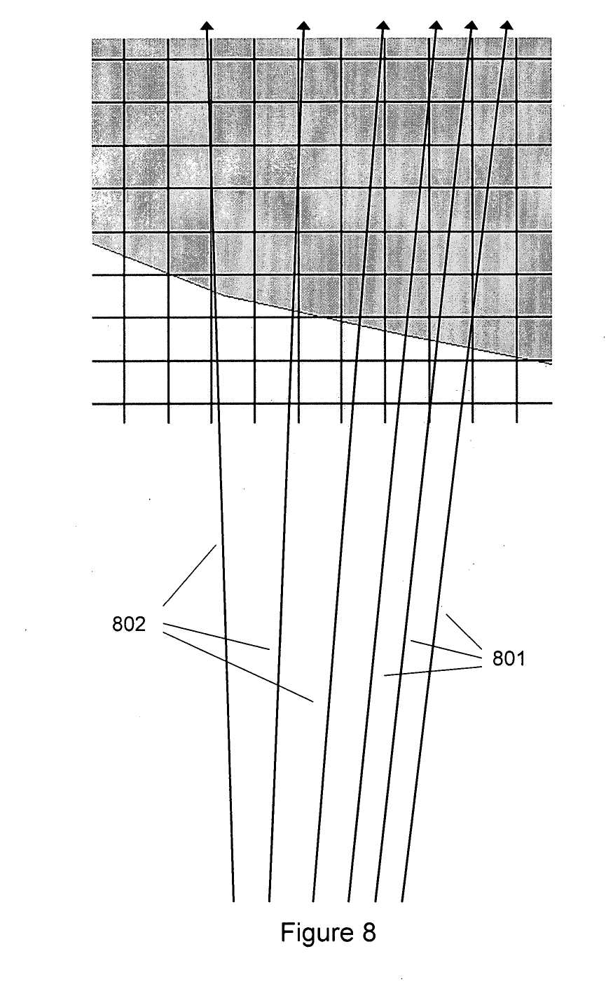

FIG. 8 shows ray tracing being performed at a variable spatial density. In another embodiment of the present invention, alternatively to performing a single ray trace from each point source to the center of each voxel, ray tracing may be performed at a prescribed spatial resolution, where the primary-photon flux is calculated in each voxel the ray trace passes through. In regions of sharp source gradients, ray tracing may be performed at a finer spatial resolution 801, and in regions where source gradients are relatively small, ray tracing is performed at a coarser spatial resolution 802. In another embodiment of the present invention, ray tracing may be performed directly to Gaussian integration points, for a prescribed integration order, within computational elements used for the photon transport or electron-transport calculations.

In one embodiment of the present invention, the optical distance calculated in ray tracing is computed on a grid with larger element sizes, and the first scattered source at each desired location is calculated using the material properties from a finer resolution grid, which may be the acquired image resolution. Numerous methods may be used to achieve optimal ray trace efficiency, which may be currently employed in other ray tracing applications.

The products of this Step (1) are the first scattered photon 302 and first scattered electron 301 sources. These sources describe the angular and energy dependent particle flux at every voxel in the ray-tracing grid to which ray tracing was performed. For each energy group, the angular flux distribution is stored as spherical harmonics moments, as given in Equations (5) and (6).

The photon and electron energy group structure should be sufficient to produce an accurate energy dependent representation of the first-scattered-photon and first-scattered-electron sources. However, the first scattered-photon source may be written out at a coarser energy resolution than that used for the ray tracing. Although the ray tracing time is largely independent of the number of energy groups, the deterministic photon-transport calculation time scales approximately linearly with the number of groups. Additionally, a relatively fine photon energy resolution in ray tracing is needed for accurate reconstruction of the first scattered-electron source.

For example, ray tracing may use 20 photon energy groups and the first scattered-electron source may be represented using 30 electron energy groups for a typical 6 MV linear accelerator. However, the 20 photon groups may be collapsed down to 5 photon groups for construction of the first scattered-photon source, with the resulting photon-transport calculation being performed using 5 energy groups. This will enable the first scattered-electron source to be accurately computed using a refined photon group structure, but will substantially shorten the photon-transport calculation time.

Ray tracing is generally performed for all point sources. The resulting first scatter sources are accumulated into a single first scattered-photon source and a single first scattered-electron source in each ray-tracing-grid voxel.

The number of moments used to construct the spherical harmonics representation of the scattering source may be higher for first scattered electrons than is used for the first scattered photons. For example, while P₅ may be required to resolve the angular variations in the first scattered-electron source, P₃ may be sufficient for representing first scattered-photon source. The number of moments used to construct the first scattered source is allowed to vary by energy group and for each particle type. For electron energy groups that fall below the spatial transport energy cutoff an isotropic (i.e.: P₀) representation may provide sufficient resolution. This energy cutoff is discussed further in Section 1.3.

1.2 Photon Transport Calculation

In Step (2) 304, the electron source produced by secondary photon interactions are calculated, where the term “secondary” refers to photon interactions in the anatomical region subsequent to the first interaction, that is, the collided flux as described by Equation (13). The formation of the un-collided photon distribution and the first collision sources are performed in Section 1.1.

A deterministic transport calculation may be performed using a method which iteratively solves the LBTE shown in Equation (13) by discretizing in space (finite-element), angle (discrete-ordinates), and energy (multi-group in energy). This class of methods is commonly referred to as “discrete-ordinates”, though the term specifically applies only to the angular discretization.

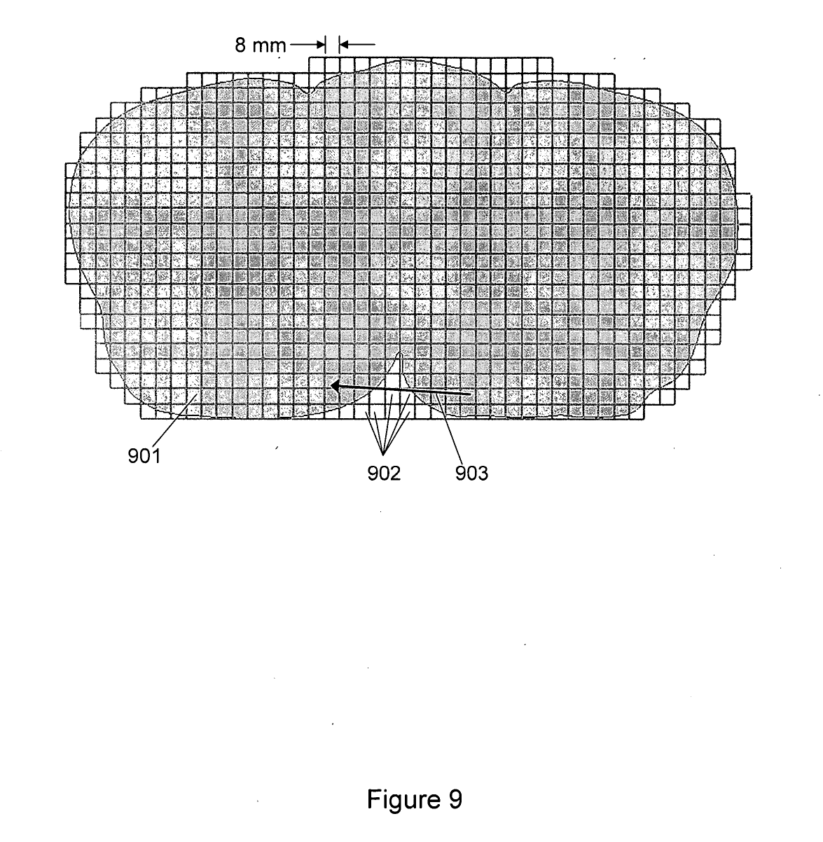

FIG. 9 shows a photon-transport grid for photon beam radiotherapy. Spatial differencing is performed on a Cartesian grid encompassing the anatomical region, referred to as the “photon-transport grid” 901. The grid may be similar, in extents, to the ray-tracing grid used in Section 1.1. However, the photon-transport grid element size will generally be larger than the ray-tracing-grid voxels. For example, for a ray-tracing-grid voxel size of 2×2×2 mm³, an element size of 8×8×8 mm³ may be used for the photon-transport calculation. Both grids may be aligned such that each photon-transport grid element contains an integral number of ray-tracing-grid voxels. As an example, an 8×8×8 mm³ photon-transport grid element may contain exactly 64 (4×4×4) ray-tracing-grid voxels.

To reduce the total element count, the perimeter of the photon-transport grid may be constructed such that photon-transport grid elements that are entirely outside and do not overlap the anatomical region are only included when necessary 902 to ensure that the photon-transport grid will allow secondary photons to pass between anatomical region boundaries without scattering in the external air 903. That is, the spatial domain will not be re-entrant.

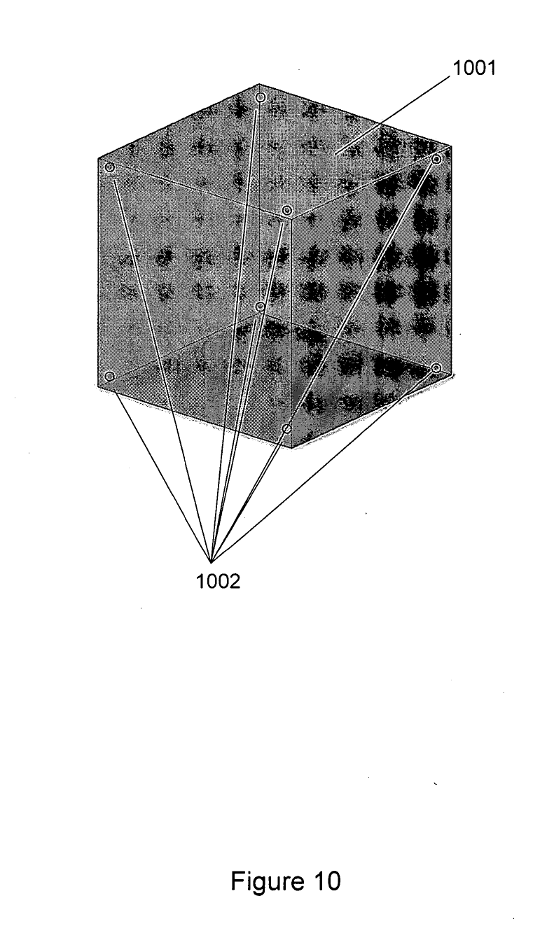

FIG. 10 shows spatial unknowns on a Cartesian element for a tri-linear discontinuous-element representation. Spatial differencing may be performed using a higher order finite-element method, for example tri-linear discontinuous-spatial differencing may be employed. As such, each Cartesian photon-transport grid element 1001 will have 8 spatial unknowns 1002, and the total spatial unknowns solved for in the photon-transport calculation is equivalent to 8 times the number of photon-transport grid elements.

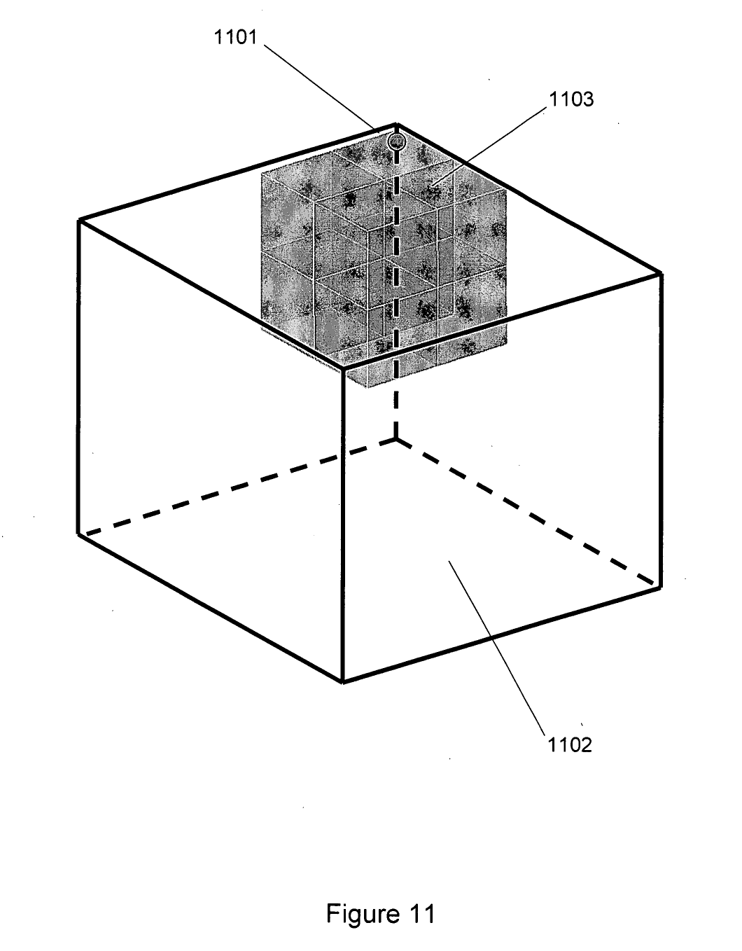

The material properties and the first scattered-photon source, computed on the ray-tracing grid, are mapped to the photon-transport grid elements. Unique material properties can be associated with each of the 8 spatial unknowns in each photon-transport grid element, resulting in a tri-linear finite-element representation of the material properties in each element. FIG. 11 shows a relationship between ray tracing grid voxels and spatial unknowns in a photon-transport grid element. Considering a photon-transport grid element size of 8×8×8 mm³ and a ray-tracing grid element size of 2×2×2 mm³, material properties at each spatial unknown 1101 in each photon-transport grid element 1102 can be obtained by homogenizing materials in the 8 ray-tracing-grid voxels 1103 associated with that corner of the photon-transport grid element. For example, the total interaction cross section for a given region can be approximated as

$${σ}_{t , node} = \frac{{\sum }_{i = 1}^{8} {σ}_{t , i} {V}_{i}}{{\sum }_{i = 1}^{8} {V}_{i}} , \qquad ( 16 )$$

where the summation is over the 8 voxels that make up the subregion associated with a finite element node. This a discrete version of Equation (1). Similarly, the first scattered-photon source at each spatial unknown in each photon-transport grid element can be obtained by calculating a volume-weighted average of the first scattered-photon source over the 8 ray-tracing-grid voxels associated with that corner of the photon-transport grid element.

Input to the photon-transport calculation will be the first scattered-photon source, Q^{scat,(u)}(\vec{r}), produced in Section 1.1, where source anisotropy is represented using spherical harmonics moments. The expansion order of the spherical harmonics moments representation of the scattering kernel is commonly referred to as the P_{N} order, where N refers to the order of the spherical harmonics moments expansion. While increasing the P_{N} order will allow for a more accurate representation of anisotropic scattering, it will also increase computational times and memory consumption. The photon-transport calculation may employ a variable P_{N} order to preserve accuracy while minimizing computational overhead.

First, a higher P_{N} order may be used for representing the first scattered-photon source than is used in the photon transport iterations. In this manner, the anisotropic first scattered-photon source is modeled with greater fidelity than the collided flux that is used to model the secondary interactions.

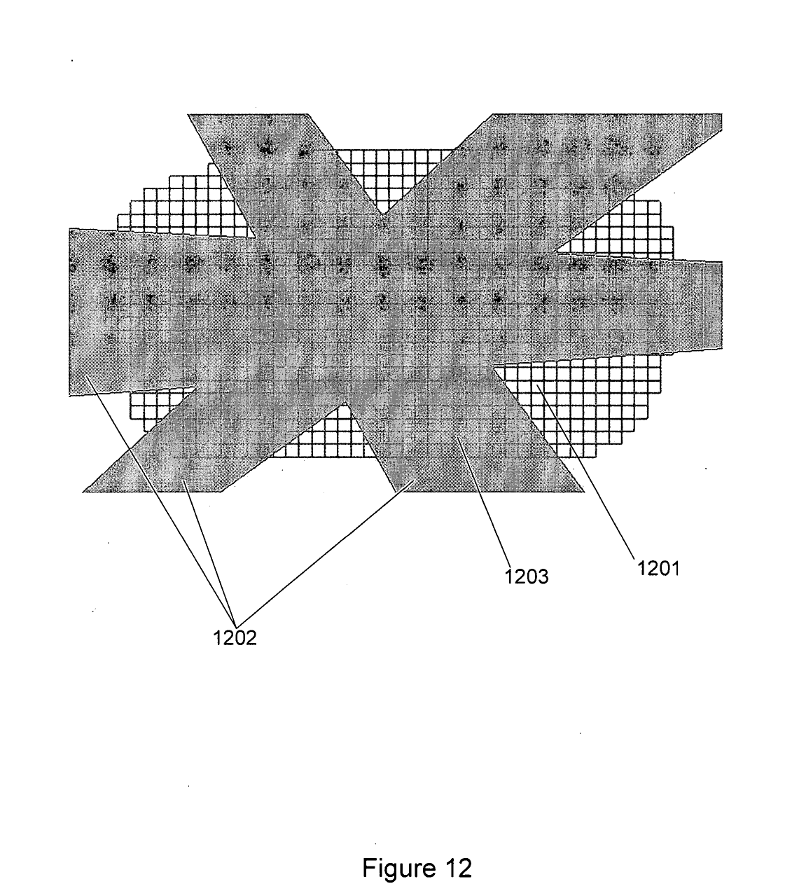

Secondly, adaptation in the P_{N} order may be performed based on proximity to the primary beam(s). FIG. 12 shows a photon-transport grid with radiotherapy beams. For example, photon-transport grid elements which are external 1201 to the primary beam(s) 1202 may be assigned a lower P_{N} order than those located in the primary beam(s) paths 1203. The criteria for this may be the total photon flux resulting from the primary component in each photon-transport grid element, which is calculated by the ray-tracing method described above in Section 1.1. In this manner, a threshold value, Φₜᵥ, may be defined where elements having a total photon flux exceeding the threshold are considered inside the beam path. This may be determined by: (1) evaluating the primary flux, Φ₍ᵢⱼ₎, at each spatial unknown, j, 1002 in each element, i, in the photon-transport grid; (2) finding the location in each element where the maximum flux occurs in that element, jₘₐₓ; and (3) evaluating whether Φ₍ᵢⱼₘₐₓ₎≧φₜᵥ. If this criterion is satisfied, a higher P_{N} order should be considered to more accurately represent the scattering source in this element. For this discussion, the primary flux is equivalent to the zero^{th} flux moment

$$\begin{matrix}{ϕ}_{0}^{0} ( \vec{r} , {E}^{′} ) = {\int }_{4 π}^{} {Y}_{0}^{0} ( {\hat{Ω}}^{′} ) Ψ ( \vec{r} , {E}^{′} ) ⅆ {\hat{Ω}}^{′} \\ = {\int }_{4 π}^{} Ψ ( \vec{r} , {E}^{′} ) ⅆ {\hat{Ω}}^{′} .\end{matrix} \qquad ( 17 )$$

As an example for P_{N} order adaptation, the expansion order of the first scattered-photon source may be represented as P₄, while the scattering source for secondary interactions for elements in the beam path(s) may be represented as P₂ and the scattering source for secondary interactions for elements external to the beam path(s) may be represented as P₁.

The angular discretization may be adapted by energy group. In this manner, a variable angular quadrature order, referred to as the S_{N} order, by photon energy group may be employed. In this manner, a higher S_{N} order may be applied for higher energy photon groups, with a lower S_{N} order applied to lower energy photon groups. To accelerate convergence, the initial field guess for each photon energy group may be based on the solution of the previous energy group.

The output of the photon-transport calculation is an electron-scattering source 305, which represents the angular and energy distribution of electrons produced by secondary photon interactions in the anatomical region, where the term “secondary” refers to photons interactions subsequent to the first photon collision. The secondary photon interactions are also known as the collided flux. This source may be output at the electron energy group resolution used for the electron-transport calculation.

The spatial resolution of the output secondary electron-scattering source may be equal to that of the ray-tracing-grid voxels. Thus, for an 8×8×8 mm³ photon-transport grid element, the secondary electron-scattering source may be output at 64 (4×4×4) locations. The source at each location can be projected onto the finer resolution mesh by using the FEM tri-linear representation that exists for each element.

1.3 Electron Transport Calculation

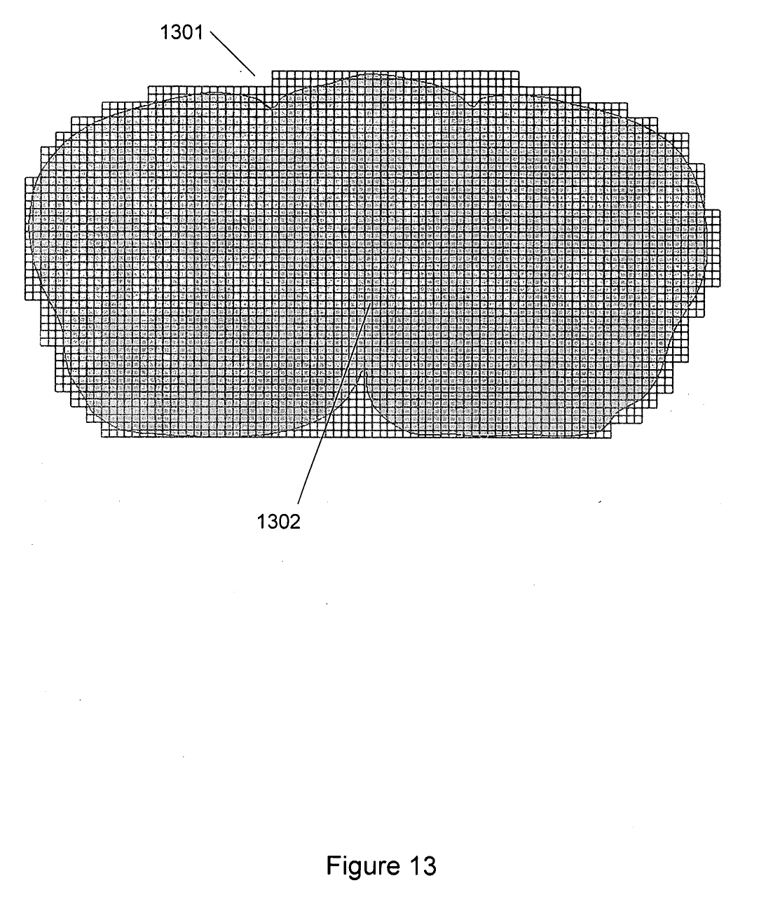

FIG. 13 shows an electron-transport grid. For the Step (3) 306 electron-transport calculation, a Cartesian grid 1301 is constructed for the electron-transport calculation which encompasses the anatomical region 1302. Referred to as the “electron-transport grid,” the extent of this grid may be the same as that of the photon-transport grid, but elements in the electron-transport grid may be smaller than those in the photon-transport grid. For example, assuming a ray-tracing-grid voxel size of 2×2×2 mm³, and a photon-transport grid element size of 8×8×8 mm³, an element size of 4×4×4 mm³ may be used for the electron-transport grid. The resolution of the each transport grid is chosen to resolve the spatial solution. Because electrons have shorter ranges between collisions when compared to photons, the electron-transport grid is usually chosen to be more refined than the photon-transport grid so that the quality of the final solution is maintained.

Prior to the start of the electron-transport calculation, the extents of the electron-transport grid may be reduced such that electron transport is only performed in elements internal or adjacent to the primary beams. In order to select elements to be deactivated, a parameter may be defined to represent the minimum dose level of clinical interest for the desired calculation, Dₘᵢₙ, which may be a ratio based on the maximum dose, ranging from 0.0 to 1.0. For example, a Dₘᵢₙ value of 0.4 would mean that only doses greater than 40% of that at the maximum dose point, Dₘₐₓ, are of interest. For each electron-transport grid element, the element may satisfy this criteria if the value in any tracing grid voxel contained in that element satisfies this criteria.

Since adaptation is performed prior to the electron-transport calculation, the dose field from the electron transport has not been calculated at the time of adaptation. Therefore, the adaptation criteria may be based on a dose quantity obtained from the photon flux field, such as KERMA, defined as the kinetic energy released per unit mass, which provides a reasonable estimate of the dose magnitude. Alternatively, the primary or secondary photon flux, or any combination thereof, may also be used.

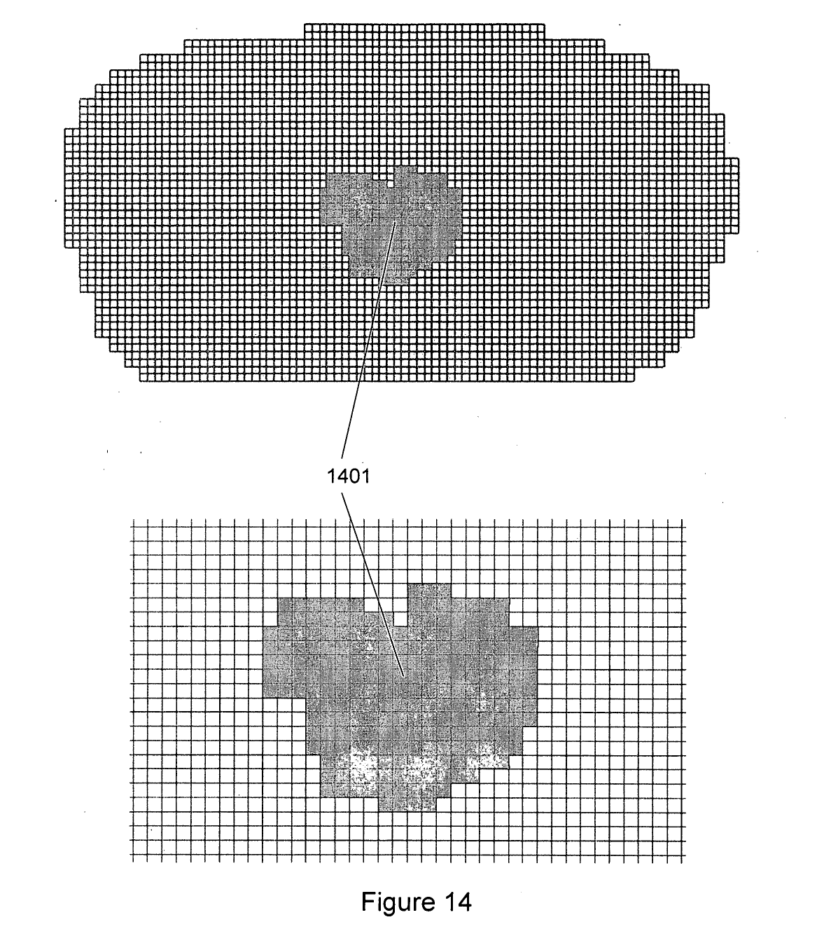

FIG. 14 shows a subset of elements in the electron-transport grid selected for adaptation. A search is performed among elements in the electron-transport grid, to create an element set of all electron-transport grid elements which satisfy the above criteria 1401.

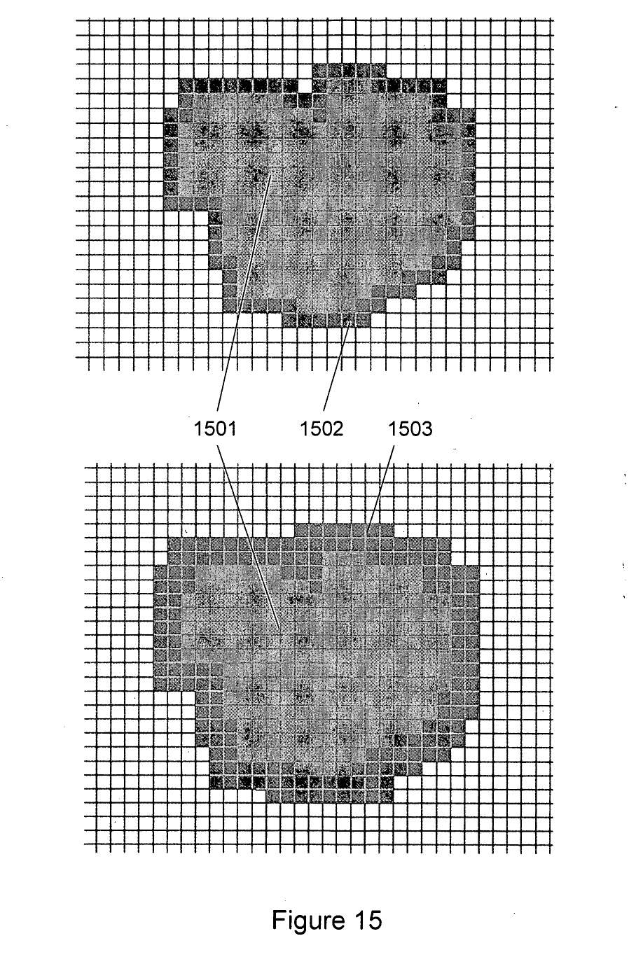

FIG. 15 shows additional elements added for adaptation, surrounding those originally selected for adaptation in FIG. 14. It is then necessary to expand this element set 1501 to include a buffer region 1502 which is thick enough that electrons at the boundary of the resulting electron-transport grid do not significantly influence the dose field in regions where doses are greater than Dₘᵢₙ. A parameter, N_{layer}, is provided that specifies the number of element layers which should be added to the element set. Specifying this parameter would be based on the optical depth of the cells and the mean free path of the electrons. One possibility is:

$${N}_{layer} = ⌈ {c}_{layer} \frac{mfp}{Δ {x}_{grid}} ⌉ = ⌈ \frac{{c}_{layer}}{{\sum }_{t} Δ {x}_{grid}} ⌉ , \qquad ( 18 )$$

where the mean free path, mfp is the reciprocal of the macroscopic cross section, Σₜ, and the grid element has a width of ΔX_{grid} and the free parameter c_{layer} can be tuned as needed. Elements adjacent to elements in the element set, defined by sharing a common surface (or edge or point in other embodiments) with elements in the element set, are added to the element set. This step is repeated N_{layer} times, each time calculating adjacencies to all previously selected elements. FIG. 15 shows a resulting buffer region with N_{layer}=2 1503.

The above approach may have limitations if low density materials such as air or lung are contained in the elements in the layers added in the buffer region. In these types of regions, electrons have a long mfp and electrons originating beyond the buffer region boundary may significantly influence the dose in regions of interest. In such cases, the buffer region thickness may be locally increased to account for low density regions as shown in Equation (18).

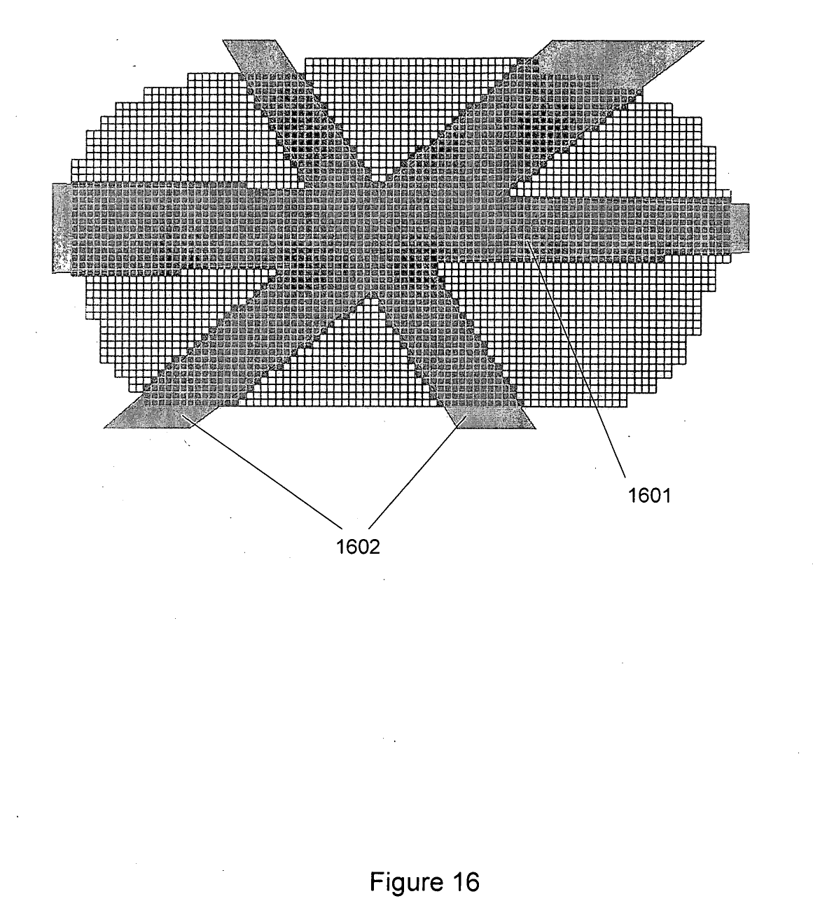

If Dₘᵢₙ is set sufficiently low, 0.10 for example, the selected elements may include all elements inside the primary beam paths, and the buffer region may include elements contained in and immediately outside the beam penumbra. FIG. 16 shows elements selected for adaptation based on proximity to the radiotherapy beams. FIG. 16 shows an example where the Dₘᵢₙ criteria is based on a measure of the primary-photon flux alone, and selected elements 1601, prior to adding the buffer region, are either inside or partly overlapping the primary beams 1602.

The electron-transport calculation is generally the single most time-consuming step in the dose calculation process. The higher resolution mesh for the electron field, combined with often large anatomical regions, can result in a large number of elements in the electron-transport grid. Since sharp solution gradients due to electron scattering may be relatively localized, and since much of the anatomical volume may have doses low enough to not be of clinical interest, spatial adaptation can provide a useful means of reducing the electron-transport calculation time.

As shown in Equation (9), the electron-scattered source drives the transport problem that must be solved. The electron-scattered source has two components, the first scattered-electron source 303, calculated in Section 1.1, and the electron source produced by secondary photon interactions 305, calculated in Section 1.2. Both of these sources may be merged together to create a single input source, having a P_{N} expansion order for each energy group equal to that of the first scattered-electron source at the corresponding energy group.

Variable material properties may be employed in each electron-transport grid element. In each element, spatially variable material properties may be employed, using the same finite-element representation as that used to solve the transport equations. If materials in the refined electron-transport grid elements are mapped from ray-tracing-grid voxels of the same size, only a single material property can be applied to each element. In such cases, the finite-element representation of the material properties in each element may be based on materials from the original image pixels, which may be smaller than the ray-tracing-grid voxels. In such cases, the first scattered-electron source distribution in each adapted element may be obtained by ray tracing to the center of each image pixel contained in the adapted element, and constructing the first scattered source from the material in each image pixel.

Similar to the photon-transport calculation, an adaptive P_{N} order may be employed. Here, a higher P_{N} order is used for construction of the first scattered-electron source than is used in the electron transport iterations. Similarly, the P_{N} order in elements external to the primary beam paths may have a lower P_{N} order than those within the primary beam paths. As an example, the electron source produced by merging the electron sources from steps 1.1 and 1.2 together may have an expansion order represented as P₅, while the scattering source for secondary interactions for elements in the beam path(s) may be represented as P₃, and the scattering source for secondary interactions for elements external to the beam path(s) may be represented as P₁.

The angular discretization may be variable by energy group. In this manner, a variable angular quadrature order, referred to as the S_{N} order, by electron energy group may be employed. A higher S_{N} order may be applied for higher-energy electron groups, with a lower S_{N} order applied to lower energy electron groups. In general, the S_{N} order for the electron groups will be lower than that used for the photon groups.

The resulting electron field can be calculated by deterministically solving the 3-D, steady state, Generalized Boltzmann-Fokker-Planck transport equation (GBFPTE) with the continuous-slowing-down operator for charged particles,

$$\hat{Ω} \cdot \vec{∇} Ψ ( \vec{r} , E , \hat{Ω} ) + {σ}_{t} ( \vec{r} , E ) Ψ ( \vec{r} , E , \hat{Ω} ) - \frac{\partial }{\partial E} β ( \vec{r} , E ) Ψ ( \vec{r} , E , \hat{Ω} ) - Λ ( \vec{r} , E , \hat{Ω} ) = + {\int }_{0}^{∞} ⅆ {E}^{′} {\int }_{4 π}^{} {σ}_{s} ( \vec{r} , {E}^{′} \to E , \hat{Ω} \cdot {\hat{Ω}}^{′} ) Ψ ( \vec{r} , {E}^{′} , {\hat{Ω}}^{′} ) ⅆ {\hat{Ω}}^{′} , \\ \vec{r} ∈ V , \\ ∀ \hat{Ω} = 0 … 4 π , \\ E = 0 … ∞ , \qquad ( 19 )$$

along with appropriate boundary conditions. Here, \vec{r} is the particle position in space, \hat{Ω} is the particle direction of travel, E is the particle energy, σₜ, is the macroscopic total cross section, σₛ is the macroscopic differential scattering cross section for soft collisions, β is the restricted stopping power, Ψ is the particle angular flux and it is assumed that there is no fixed source. The term A represents any additional higher order Fokker-Planck terms that may be used in addition to the continuous slowing down operator, ∂(βΨ)/∂E, which is the first-order term of the Fokker-Planck expansion.

The GBFPTE includes all terms of the LBTE, including Boltzmann scattering for the nuclear interactions (catastrophic collisions), with the addition of the continuous slowing down operator and Λ, which account for Coulomb interactions (soft collisions).

An electron energy cutoff may be employed to ignore the spatial transport of electrons below a specific energy, E_{cut}. Below this energy, it is assumed that the particles will only travel a very small distance before being absorbed, which can be neglected. For each electron-transport grid element, the following approximation to Equation (19) will be solved for all particles that have an energy below the cutoff value,

$${σ}_{t} ( \vec{r} , E ) Ψ ( \vec{r} , E , \hat{Ω} ) - \frac{\partial }{\partial E} β ( \vec{r} , E ) Ψ ( \vec{r} , E , \hat{Ω} ) - Λ ( \vec{r} , E , \hat{Ω} ) = + {\int }_{0}^{∞} ⅆ {E}^{′} {\int }_{4 π}^{} {σ}_{s} ( \vec{r} , {E}^{′} \to E , \hat{Ω} \cdot {\hat{Ω}}^{′} ) Ψ ( \vec{r} , {E}^{′} , {\hat{Ω}}^{′} ) ⅆ {Ω}^{′} , \\ ∀ 0 \leq E < {E}_{cut} . \qquad ( 20 )$$

Effectively the particles are no longer transported in space and Equation (20) can be solved for each element in the transport grid. Each cell is independent of the others. This equation can be further reduced by integrating over all angles so that

$${σ}_{t} ( \vec{r} , E ) ϕ ( \vec{r} , E ) - \frac{\partial }{\partial E} β ( \vec{r} , E ) ϕ ( \vec{r} , E ) = {\int }_{0}^{∞} ⅆ {E}^{′} {σ}_{s , 0} ( \vec{r} , {E}^{′} \to E ) ϕ ( \vec{r} , E ) , \\ ∀ 0 \leq E < {E}_{cut} . \qquad ( 21 )$$

Equation (21) is independent of angle and is solved for each electron-transport grid element. In one embodiment of the present invention, the spatial transport of electrons below a defined energy cutoff will be ignored, either explicitly through solving the above equations, or by applying previously calculated response functions for energy deposition as a function of material properties based on the above equations.

In radiotherapy treatment planning, simulations may often be performed which represent small perturbations from conditions used in a previous simulation. In such cases, the solution field calculated in the previous simulation may be used as the starting flux guess for a subsequent calculation, which can reduce the number of iterations per energy group required for convergence. This can be applied for any particle type. For example, in a coupled photon-electron-transport calculation, the deterministic photon-transport calculation can use the previous photon flux field as the starting flux guess, and the deterministic electron-transport calculation can use the previous electron flux field as the starting flux guess. In another embodiment of the present invention, the initial field guess for each electron energy group may be based on the solution of the previous energy group.

Solving the electron transport problem produces an energy-and-angular-dependent electron-particle distribution for every location in the problem domain. The node values that are computed define a solution at all locations through each element's finite element basis functions.

1.4 Dose Output

In external beam radiotherapy, multiple means of evaluating patient doses may be of interest, including equivalent dose-to-water (D_{W}), dose-to-medium (D_{M}), or biologically effective doses. For D_{W}, a single flux-to-dose response function may be applied over the entire anatomical region, which converts the angle integrated, energy dependent electron flux into an equivalent dose-to-water. In general, photon-energy deposition is insignificant relative to the electron doses, and thus only electron doses need to be calculated. For calculation of both D_{M} and biologically effective doses, response functions may be based on local material properties.

The dose may be output at a finer spatial resolution than that of the electron-transport grid elements. For example, this may be at the resolution of the ray-tracing-grid voxels, or alternatively at the image pixel resolution. With higher order differencing methods, such as tri-linear discontinuous-spatial differencing, a spatially variable electron flux representation is calculated within each electron-transport grid element.

As an example, consider an electron-transport grid element size of 4×4×4 mm³, a ray-tracing-voxel grid size of 2×2×2 mm³, and an image pixel size of 1×1×1 mm³. If D_{W} is desired at the image-pixel resolution, the dose may be obtained by calculating the scalar electron flux distribution at the center of the corresponding image pixel based on the finite element integration rules in that electron-transport grid element, then applying the dose-to-water response function to this scalar flux distribution. This is repeated for all 64 pixels located within each electron-transport grid element. If D_{W} is desired at the ray-tracing-voxel grid resolution, the scalar electron flux distribution may first be calculated at each of the 8 image pixels contained in the ray-tracing-grid voxel, followed by applying the dose-to-water response function to the average of the scalar flux distribution over all 8 pixels. This is repeated for all 8 ray-tracing-grid voxels within each electron-transport grid element. If D_{M} is desired at the image pixel resolution, the dose may be obtained by calculating the scalar electron-flux distribution at the center of the corresponding image pixel based on the finite element integration rules in that electron-transport grid element, then applying the dose-to-medium response function specific to the material of the associated image pixel to this scalar flux distribution. Alternatively, D_{M} could be calculated at the image pixel level by averaging the scalar electron flux distribution calculated at each of the 8 image pixel locations contained in the ray-tracing-grid voxel, and then applying the dose-to-medium response function specific to the material of the associated image pixel for each of the 8 image pixels located within the ray tracing voxel. D_{M} could then be output at the image pixel resolution, or output at a coarser resolution, such as the ray-tracing grid by averaging over multiple locations.

2. Dose Calculations During Treatment Plan Optimization

In photon beam radiotherapy, dozens of dose calculations may be performed in the development of a single optimized treatment plan. In one embodiment of the present invention, the following variants of the methods described in Section 1 may be used to accelerate the dose calculation process during treatment plan optimization.

2.1 Generation of Electron-Transport Grid

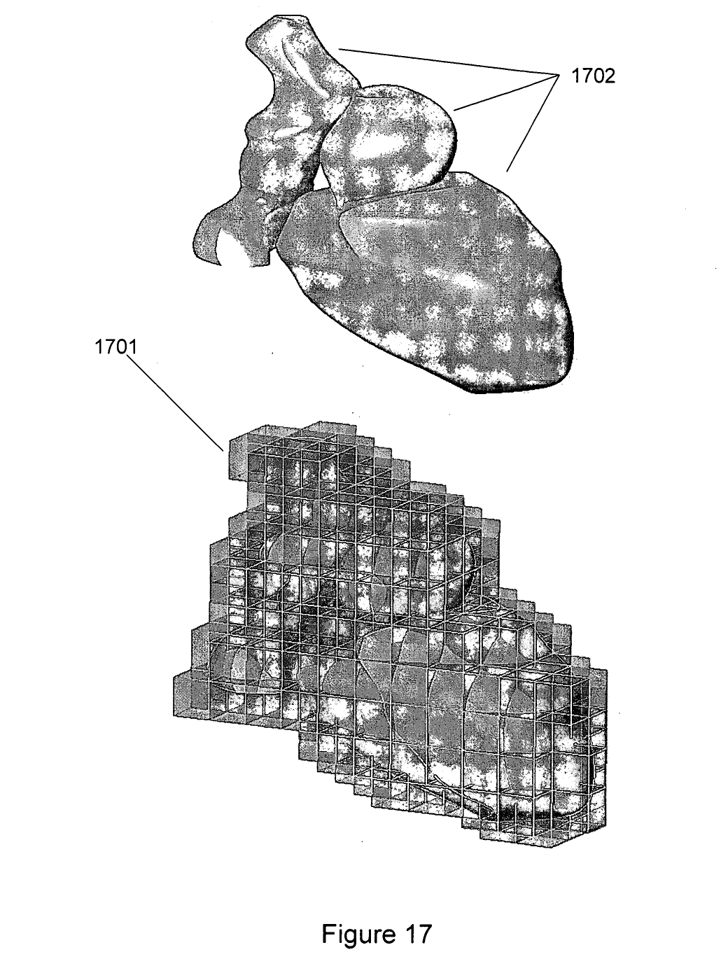

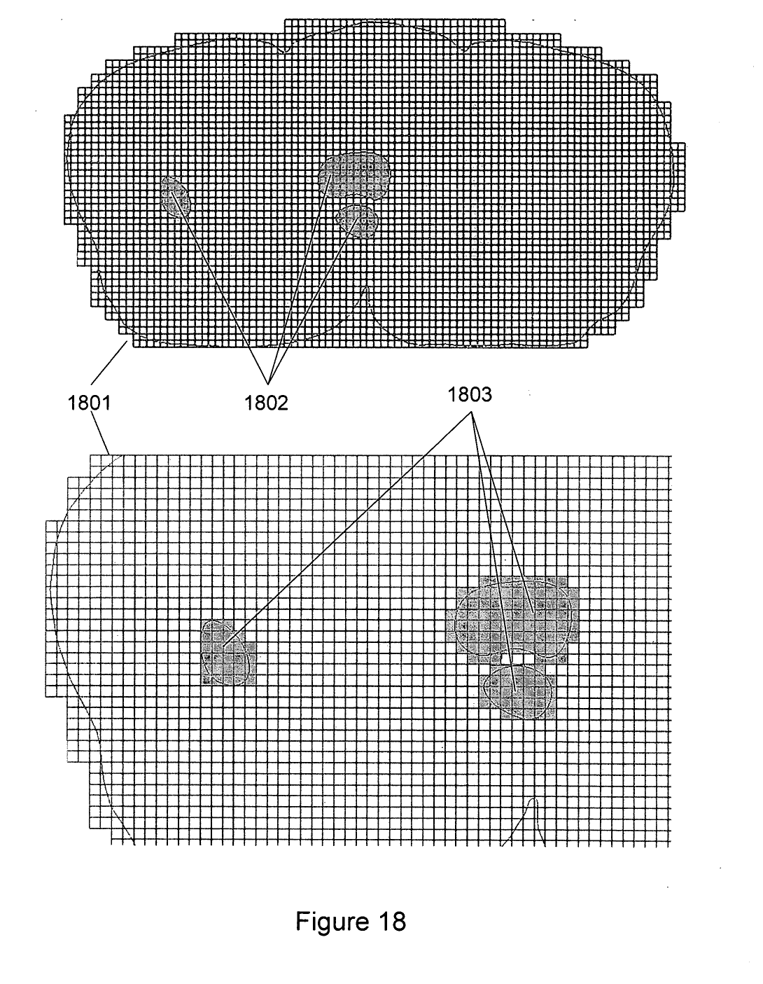

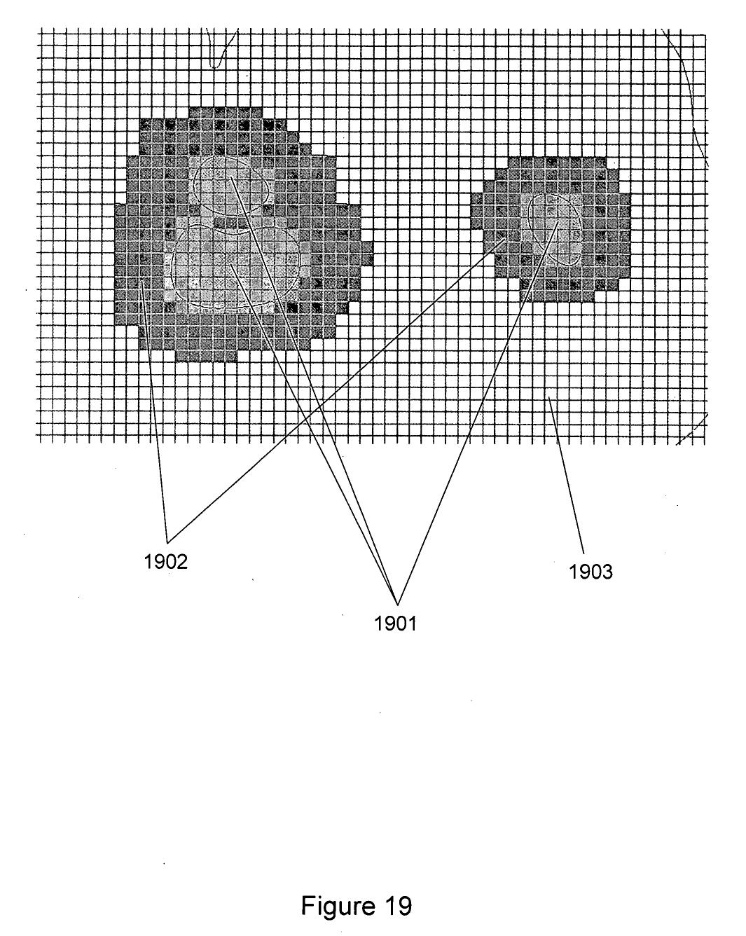

The electron-transport grid may be generated prior to the start of dose calculations, based on proximity to contoured regions, such as the planning treatment volume and critical structures. First, an electron-transport grid 1301 is created to encompass the full anatomical region 1302. FIG. 17 shows elements selected for adaptation based on proximity to regions of interest. Second, an isotropic electron volume source is assigned to each electron-transport grid element 1701 which is located inside or overlaps physician contoured structures 1702 such as the planning treatment volume or critical structures. FIG. 18 shows electron-transport grid elements which are contained in, or overlap, physician contoured regions. FIG. 18 presents a 2-dimensional view, showing the electron-transport grid 1801, contoured structures 1802, and electron-transport grid elements where the volume source is applied 1803. The spectrum for this source is equivalent to the desired energy dependent dose response function for the dose value of interest (D_{M}, D_{W}, etc.). Third, an adjoint electron-transport calculation is performed to compute the adjoint electron flux in every element in the electron-transport grid. Fourth, the adjoint flux in each electron-transport grid element is integrated over all angles and energy groups, to determine the total adjoint flux in each element. Fifth, if the total adjoint flux in any element is less than a prescribed threshold, that element is deleted from the electron-transport grid. The threshold value is assigned such that an electron flux in elements where this value is not satisfied will result in a negligible contribution to the dose regions of interest. FIG. 19 shows electron-transport grid elements in near proximity to contoured regions. The resulting electron-transport grid includes only elements which are either inside or overlap the contoured regions 1901 or are outside of the contoured regions but where an electron flux in such elements may contribute significantly to the dose in the contoured regions 1902. All other elements 1903 may be deleted. The above considerations provide a rigorous method to calculate which electron-transport grid elements are necessary for inclusion into a dose calculation where the dose distribution in one or more specific regions is of interest.

In one embodiment of the present invention, a separate electron-transport grid may be generated for each contoured region. In another embodiment of the present invention, a separate electron-transport calculation may be generated on each region, where different element sizes may be applied for each region. In this manner, separate electron-transport calculations may be performed on the electron-transport grid associated with each region. In another embodiment of the present invention, the adjoint source is only prescribed on those elements which are located at the perimeter of each region, rather than in every element located inside that region.

2.2 Ray Tracing

Once a gantry position is specified, ray tracing may be performed to generate the first-scattered-photon and first-scattered-electron sources in each ray-tracing-grid voxel where ray tracing is performed. This may be performed prior to any dose calculations for that gantry position, or in the first dose calculation using that gantry position. After ray tracing is performed, the first scattered photon and first scattered-electron sources are created for each energy group to be used in the subsequent photon and electron-transport calculations, and are stored, in memory or disk, for use in subsequent dose calculations.

Once a gantry position is specified, the locations of the associated photon point sources are known. For a given ray-tracing-grid voxel, therefore, the ray trace direction from a given point source is also known, as is the optical distance from the point source to that voxel. Therefore, each ray trace needs to be performed only once for each source at a given gantry position. After the initial ray tracing, the first scattered-photon source and first scattered-electron source are stored, in memory or on disk, for each photon and electron energy group to be used in the transport calculations. For subsequent dose calculations, the first scattered-photon source and first scattered-electron source constructed in each ray-tracing-grid voxel can be read in from memory, or disk, and scaled up or down based on the intensity of the source photon group.

If ray tracing is performed prior to any dose calculations, for a given gantry position, the ray-tracing-grid voxels may be selected to include only those voxels which exist in the path of ray traces which intersect the PTV and a buffer region surrounding the PTV. The buffer region is selected to account for attenuation and scatter through field-shaping devices and the finite spatial resolution of the field-shaping devices.

When the electron-transport grid is reduced through the method in 2.1, the first scattered-electron sources are only computed in ray-tracing-grid voxels which are located inside active electron-transport grid elements. In other ray-tracing-grid voxels, only the first scattered-photon source is generated.

2.3 Photon-Transport Calculation

The photon-transport calculation is performed on a photon-transport grid with larger element sizes than that used for the electron-transport calculation. The output of this step is an electron source which is used as input for the electron-transport calculation. The electron source is only generated in locations which overlap active electron-transport grid elements.

In one embodiment of the present invention, the dose resulting from secondary photons can be approximated by a response function, such as KERMA, rather than solving for the spatial transport of electrons produced by secondary photon interactions.

2.4 Electron Transport Calculation

The electron-transport calculation is performed using the first scattered-electron source and secondary electron source, computed in Sections 2.2 and 2.3, respectively, on elements in the reduced electron-transport grid determined in Section 2.1. In one embodiment of the present invention, a separate electron-transport calculation may be performed for each different electron-transport grid element size.

3. Adaptation for the Electron Transport Calculation

Adaptive methods may be employed to assist the deterministic transport solver's ability to capture solutions with steep spatial gradients rapidly, such as those found near material boundaries or within the beam penumbra. Adaptive methods include but are not limited to local mesh refinement and the localized use of higher-order finite-element methods

Criteria for adaptation may be evaluated prior to the start of the electron calculation. This may be based on the magnitude and local gradients of the electron-scattering source, as well as local material properties. The electron-scattering source is a driver of the electron-transport calculation and represents the scattered-electron source resulting from both the first-collided and secondary-photon interactions, calculated in Sections 1.1 and 1.2, respectively. By using these criteria, either separately or in combination with one another, adaptation may be performed prior to the start of the electron-transport calculation.

In external photon beam radiotherapies, the sharpest solution gradients generally occur in the following areas: (1) the beam penumbra, resulting from gradients in the primary photon source, (2) in the build-up regions, resulting from the air-tissue interface at the anatomical region perimeter, and (3) near internal heterogeneities, where electron disequilibrium effects are also present. Areas (2) and (3) are material heterogeneity driven effects, and are generally only significant when they are located internal to the beam paths. The adaptation criteria, therefore, should seek to adapt on heterogeneities only when they are located within the beam paths.

Parameters used to determine candidate areas for adaptation are defined as follows. Qₑₘᵢₙ represents the minimum value for the total electron-scattering source magnitude in any ray-tracing-grid voxel required to satisfy the criteria for adaptation, where the term “total” refers to the summation over all electron energy groups. Preferably, this parameter is defined as a ratio and is valued in the range 0.0 to 1.0, where Qₑₘᵢₙ=Qᵥₒₓₑₗ/Qₘₐₓ. Here, Qᵥₒₓₑₗ is the total electron-scattering source in the evaluated voxel, and Qₘₐₓ may be the maximum total electron-scattering source in any ray-tracing-grid voxel. A second parameter, Q_{eΔmin}, represents the minimum value required to satisfy the adaptation criteria based on the difference in the total electron-scattering source between any adjacent ray-tracing-grid voxels. This is obtained by calculating the maximum difference in the total electron-scattering source magnitude between the evaluated ray-tracing-grid voxel and any adjacent ray-tracing-grid voxels. This may be defined as a ratio:

$${Q}_{e Δ min} = \frac{\vert {Q}_{Δ} \vert}{{Q}_{voxel}} , \qquad ( 22 )$$

where Q_{Δ} is the maximum difference between Qᵥₒₓₑₗ and the total electron-scattering source in any adjacent racy tracing grid voxel.

Alternatively to using the electron-scattering source, another parameter could be used, such as the primary-photon flux, or KERMA, both of which are calculated prior to the electron-transport calculation. However, neither of these parameters, by themselves, will provide an estimate of the resulting gradients in the electron flux field. For example, although an electron-transport grid element may have a large photon flux, if the element consists of a low density medium such as lung or air, the scattering source produced in that element will be relatively small and electron ranges will be relatively large, both of which reduce the need for adaptation. Thus, if a parameter based on photon flux or KERMA is used, preferably the parameter should also account for voxel density in some manner.

The process for adaptation may be as follows: (1) ray tracing grid voxels are evaluated with respect to the Qₑₘᵢₙ criteria; (2) voxels which satisfy the criteria are then evaluated relative to the Q_{eΔmin} criteria; (3) elements in the electron-transport grid which contain any ray-tracing-grid voxels which satisfy the above-listed criteria are placed in a new element set; (4) electron-transport grid elements adjacent to those in the element set are added to the element set, where adjacency can be defined by elements sharing a common face, edge, or node; and (5) the previous may be repeated more than once to increase the size of the region to be adapted.

The above process may be combined with alternative criteria, such as proximity to physician contoured structures. For example, a prerequisite for the above search may be that only elements which are located inside or overlap a countered region, such as the PTV or critical structures, are evaluated for adaptation.

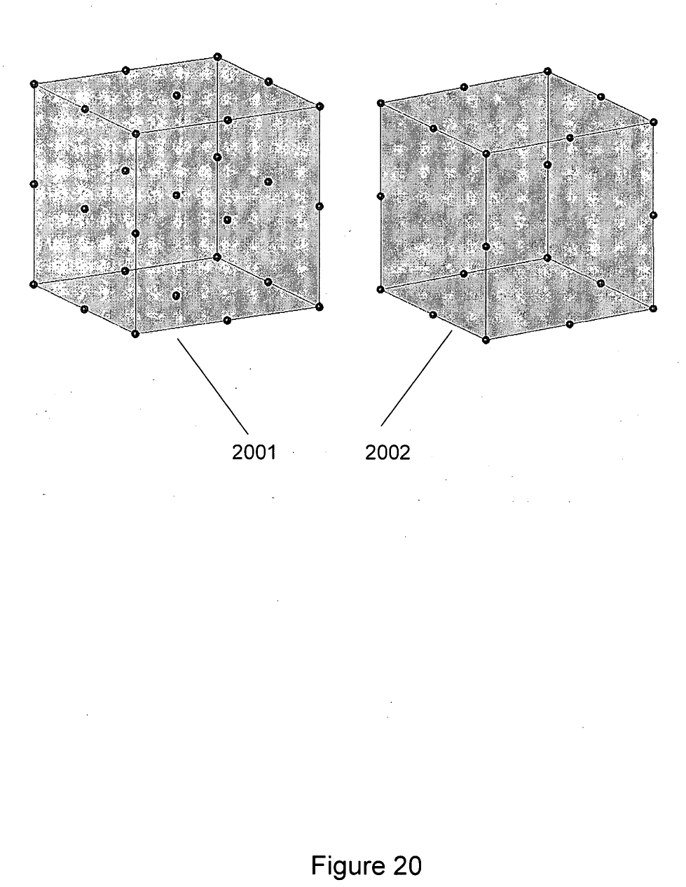

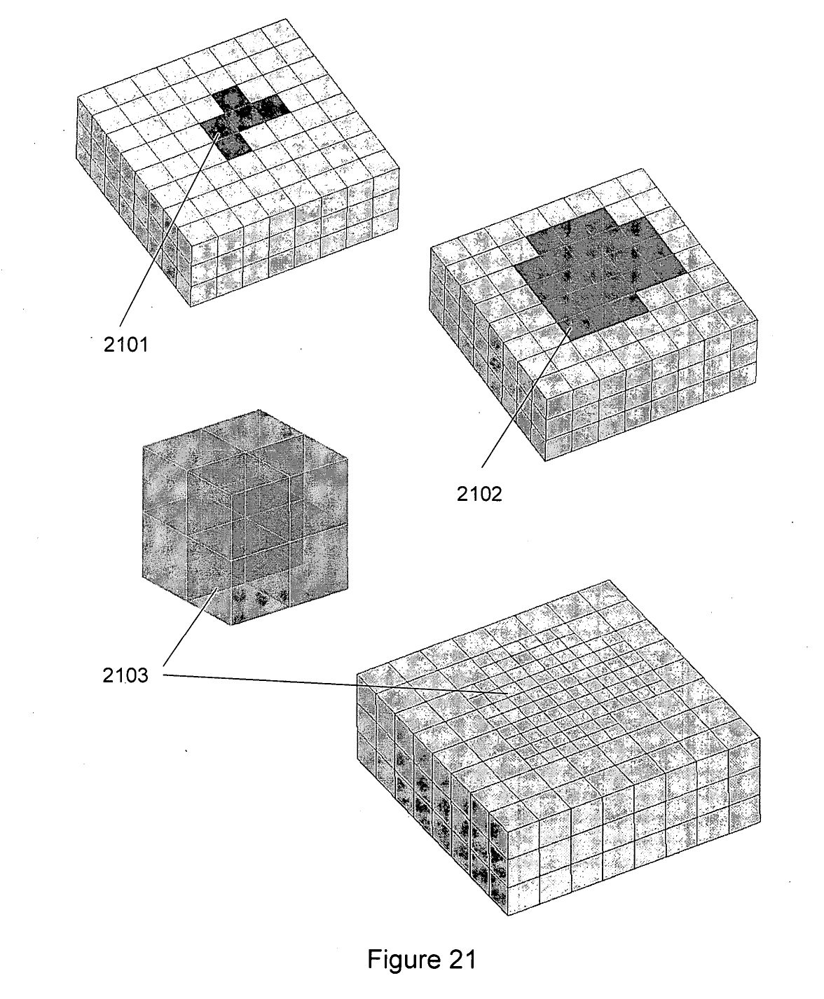

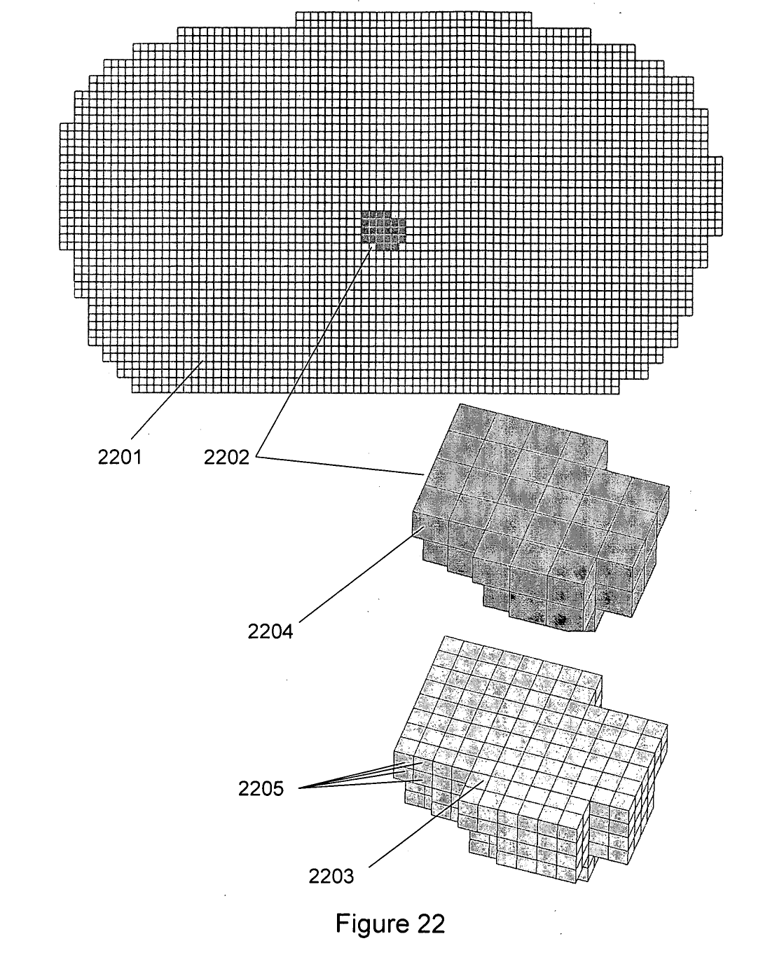

Various methods may be applied to perform the adaptation, some of which are described below:
1. Locally increasing the finite element solution order within each element, where elements selected for adaptation may solve for a higher order finite element distribution than those for which adaptation is not performed. FIG. 20 shows spatial unknowns on Cartesian elements for two different quadratic finite element representations. For example, a tri-linear quadratic representation with either 27 2001 or 20 2002 spatial unknowns may be solved in place of the standard 8 node stencil for grid locations that require more spatial accuracy. Similarly, the same finite element functions may be applied to represent the material properties in each element.
2. Local mesh refinement may be performed by refining each element to be adapted by, for example, 2×2×2. FIG. 21 shows local element refinement on electron-transport grid elements. For example, elements which satisfy the Qₑₘᵢₙ and Q_{eΔmin} criteria are first identified 2101. The element set is then expanded to include elements adjacent 2102 to the originally selected elements 2101. Each of the selected elements 2101 is then refined to create 2×2×2 elements 2103. The updated electron-transport grid will then contain a mixture of 4×4×4 mm³ and 2×2×2 mm³ elements. Alternative mesh refinement techniques may also be implemented, such as unstructured mesh structures containing tetrahedral or element types, which may preserve nodal connectivity with the unrefined elements. The use of multi-level mesh refinement may also be considered for use in place of the single-level scheme described above.
3. A process incorporating local mesh refinement may be performed, but through two separate electron-transport calculations. FIG. 22 shows electron-transport grid elements selected for adaptation, and refinement of those elements for a second electron transport calculation performed only on the refined elements. The first calculation may employ the original element sizes, 4×4×4 mm³ for example, over the full electron-transport grid 2201, including the regions to be adapted 2202. The elements selected for adaptation 2202 are then refined, or alternatively new elements are created, and the second calculation may be performed on a grid containing the refined elements only 2203, 2×2×2 mm³ for example. For the second calculation, surface boundary conditions may be applied on every external boundary face, which may be extracted from the solution in the first calculation. For example, the finite-element representation of energy and angular dependent flux on the boundary of an element in the first grid 2204, may be mapped to the four associated faces 2205 for elements in the fine grid. The dose field output may be computed from the solution on the original transport grid elements, except in regions where the second calculation is performed. In such areas, the dose may be obtained by mapping from the solution calculated at the finer grid.
   4. Brachytherapy

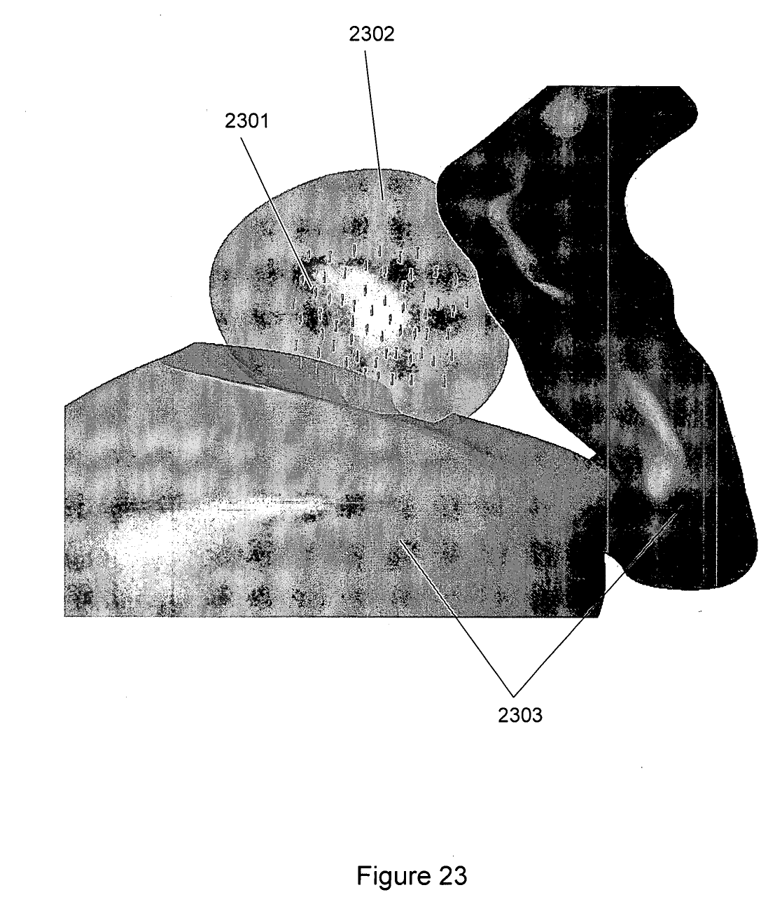

FIG. 23 shows brachytherapy sources within a treated region and adjacent regions of interest. In brachytherapy, one or more localized radioactive sources 2301 are placed within or in close proximity to a treated region 2302, and dose conformity is achieved by optimizing a brachytherapy source arrangement which can maximize dose to the treated region, while minimizing it to neighboring regions 2303.

4.1 Brachytherapy Calculation Process

Each brachytherapy source may be represented as a point source, which is anisotropic in angle and energy, and represents the exiting photon flux on the surface of the brachytherapy source. Ray-tracing of the primary-photon flux is performed in a similar manner to the process described in Section 1.1, where ray tracing is performed on a separate geometry representation from that used for the photon-transport calculation. This may be a voxel based ray-tracing grid, with voxel sizes smaller than the elements used for the photon-transport calculation. As an example, a ray-tracing-grid voxel size of 2×2×2 mm³ may be used, or alternatively an equivalent size to that of the acquired image pixels

In most brachytherapy applications spatial electron transport can be neglected, and the dose field can be obtained by a KERMA reaction rate using the energy-dependent photon flux. The energy group resolution of the ray tracing should be sufficiently fine that the dose resulting from the primary-photon flux is accurately resolved. For example, this may include 12 photon-energy groups for a ¹⁹²Ir source. The primary component of the dose field may be directly calculated using a reaction rate, such as KERMA, at the ray tracing resolution. If D_{M} is desired, KERMA may be based on the local ray-trace-voxel material, or KERMA may be based on water to obtain D_{W}. Alternatively, another response function may be applied to obtain other dose quantities, such as biologically effective doses.

The same ray-tracing method may also provide the first scattered-photon source using the approach described in Section 1.1, where angular anisotropy is represented using spherical harmonics moments for each energy group. In one embodiment of the present invention, ray tracing may be performed to Gaussian integration points, or other points, in each photon-transport grid element, rather than to ray-tracing-grid voxels. If ray tracing is performed to Gaussian integration points, the ray-tracing-grid voxels, or an alternative geometry representation, may still be used to calculate the optical depth. In such cases, the material properties used to construct the first scattered source at each Gaussian integration point may be that of the ray-tracing-grid voxel at that location, the image pixel at that location, or from an alternative geometry representation.

A first scattered-photon source is produced at each location to which ray tracing is performed, and is constructed using fewer energy groups than those from which the primary dose from KERMA was calculated. For example, while KERMA may be calculated using 12 energy groups, these 12 groups may be collapsed down to 5 for construction of the first scattered-photon source. The same energy group structure used in the creation of the first scattered-photon source may be used for the photon-transport calculation.

A Cartesian photon-transport grid is constructed covering the extents of the ray-tracing grid, for calculating the dose due to the scattered photons. The resolution of this grid is coarser than that of the ray-tracing grid. For example, a photon-transport grid element size of 4×4×4 mm³ may be used with a ray-tracing-grid voxel size of 2×2×2 mm³. Assuming tri-linear discontinuous-spatial differencing is employed, a unique source can be assigned to each of the 8 spatial unknowns in each photon-transport grid element. This can be obtained by spatially averaging the sources produced in the 8 ray trace grid voxels (2×2×2 voxels) associated with each of the 8 spatial unknowns in the photon-transport grid element.

The photon-transport calculation may be performed using an approach similar to that in Section 1.2. A group-wise variable S_{N} order may be employed to further reduce calculation times. Output of the photon-transport calculation will be the energy-dependent photon flux at each spatial unknown in the photon-transport grid, which may then be multiplied by a reaction rate, as was done for the primary-photon flux, to obtain the dose contribution from the scattered photons. The dose field may then be obtained at the resolution of the ray-tracing-grid voxels by summing the primary and scattered dose contribution at each voxel. The scattered dose contribution may be obtained by extracting the energy dependent photon flux

4.2 Accounting for Inter-Source Attenuation

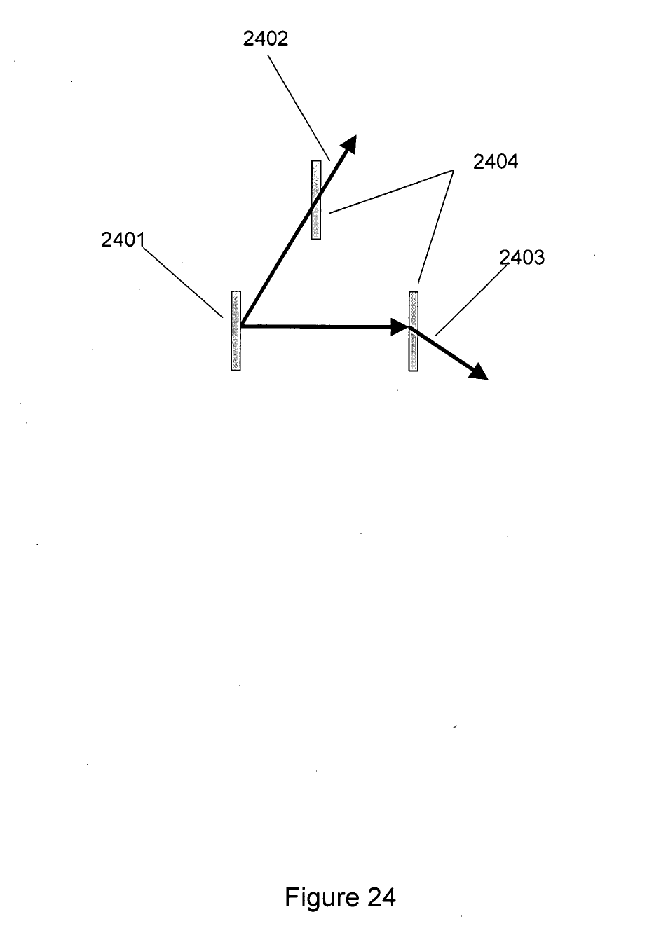

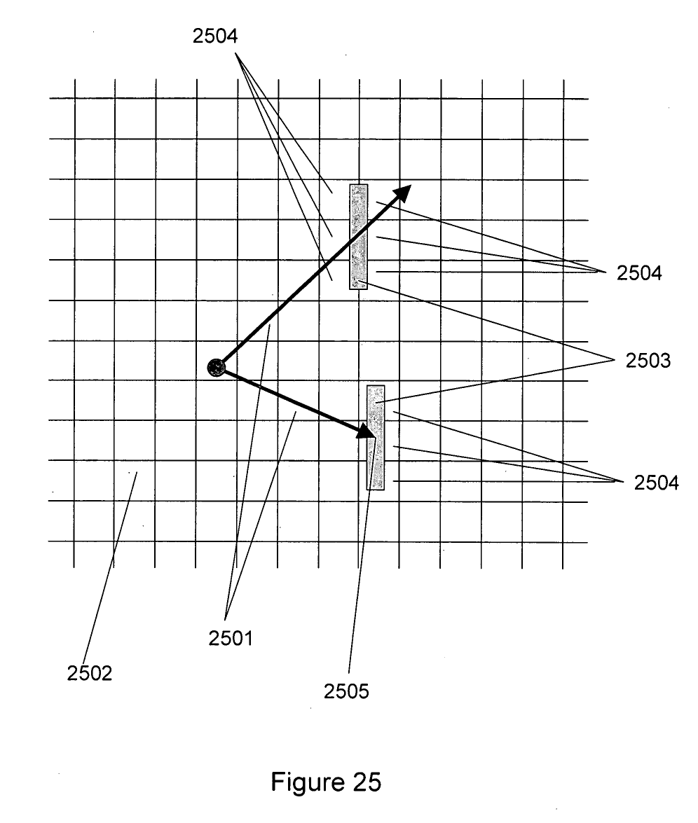

FIG. 24 shows photons emitted from one brachytherapy source being attenuated and scattered through adjacent sources. In treatments where multiple brachytherapy sources are present simultaneously in a treatment, inter-source attenuation may substantially influence the local dose distribution, where particles emitted from one brachytherapy source 2401, are attenuated 2402 or scattered 2403 as they pass through neighboring brachytherapy sources 2404. In many cases, acquired image data may not be of sufficient spatial resolution to resolve the brachytherapy source geometry. FIG. 25 shows ray tracing of the primary photons performed on both the ray tracing grid voxels and separate representations of the brachytherapy source geometries. In such cases, the ray-tracing 2501 may be calculated on both the ray-tracing-voxel grid 2502 and surface geometries 2503 representing each of the brachytherapy sources. In this manner, ray tracing is performed on the ray-tracing-grid voxels except when a ray trace traverses a source, for which the brachytherapy surface geometry, and material properties of the brachytherapy source, are applied. For ray tracing, materials in image pixels 2504 overlapping the brachytherapy source may be assigned tissue properties, so that the source material is only in the brachytherapy surface geometry, and not the image pixels. However, when the ray tracing is performed to a voxel center which overlaps the brachytherapy source geometry 2505, the first scattered source produced by ray tracing may be computed using the material properties of the brachytherapy source, and not those of the ray-tracing-grid voxel.

The brachytherapy surface geometries may then be suppressed for the photon-transport calculation, and material properties in the photon-transport grid elements may be based on those of the acquired image pixels, or alternatively prescribed properties for pixels which are overlapped by the source geometry.

If the point source represents the exiting particle flux on the surface of the brachytherapy source, ray-tracing of the primary flux from that brachytherapy source is performed without the surface geometry of the same brachytherapy source present. Similarly, materials in image pixels where the same brachytherapy source is located may be assigned tissue properties, or, alternatively, properties of a low density medium such as air or void.

For delivery modes such as high dose rate (HDR) and pulsed dose rate (PDR) brachytherapy, a single source may be attached to a cable, where its position is incrementally adjusted during the course of a treatment. Since a treatment may include numerous source positions, a preferred embodiment is to perform a single dose calculation which includes all source positions. However, a complication may be introduced by explicitly modeling all sources simultaneously in a single calculation. Specifically, inter-source shielding may cause attenuations that are not physically present. In a preferred embodiment, a method for mitigating inter-source attenuation is for the primary source to be transported, via ray-tracing, with the material properties of all image pixels where sources are modeled as an appropriate background material, using either properties from adjacent image pixels or air. The subsequent transport calculation may then be performed, using the first scattered source distribution from all points sources as input, with material properties at in the photon-transport grid obtained from the acquired image data.

4.3 Accounting for Applicators and Shields

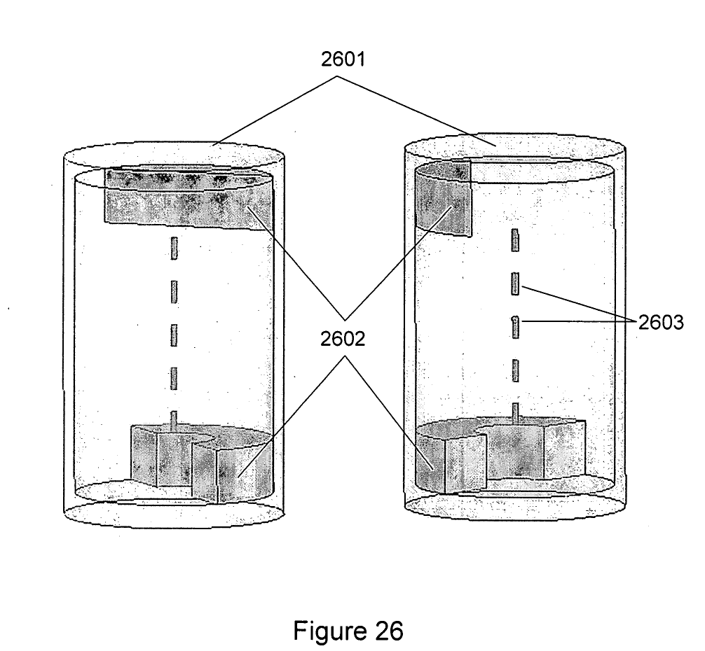

FIG. 26 shows example intracavitary brachytherapy applicators, shields, and source positions. A similar process to that described in Section 4.2 can be applied to modeling brachytherapy applicators and shields. In modalities such as intracavitary brachytherapy for cervical cancer, multiple applicators may be used 2601, sometimes with shields 2602 to reduce doses to critical structures.

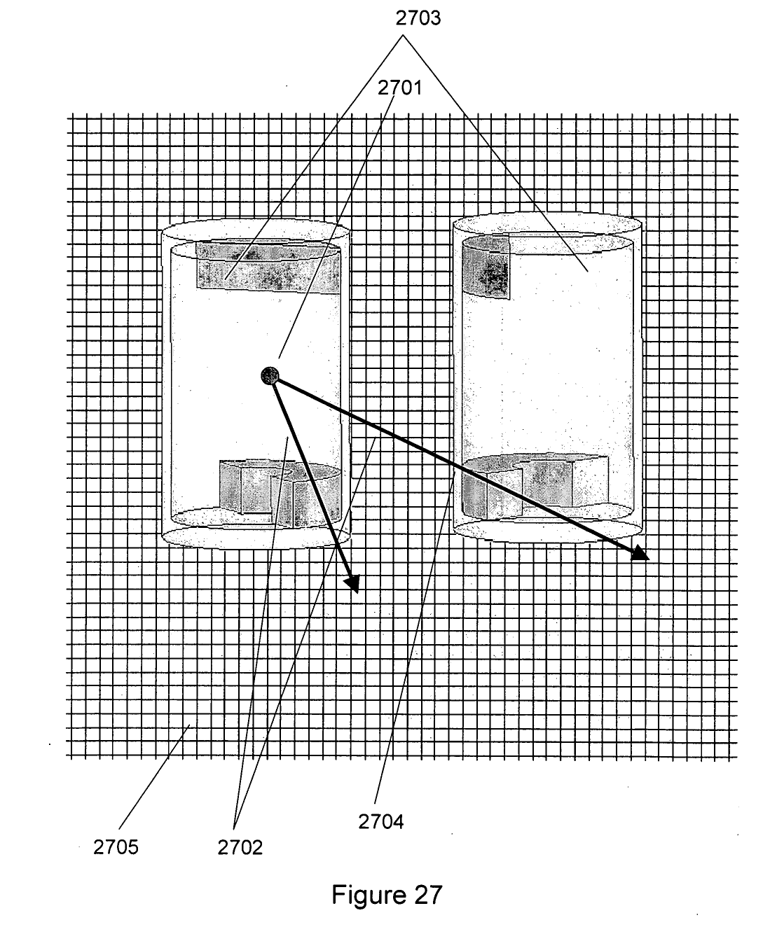

The brachytherapy sources 2603 may be represented as anisotropic point sources. Since the acquired image data may not provide a sufficient spatial resolution to resolve the shield and applicator geometries, the optical path for ray-tracing may be computed on both the ray-tracing-voxel grid and a surface geometry representing the applicators and shields. FIG. 27 shows ray tracing of the primary photons performed on both the ray-tracing-grid voxels and separate representations of the brachytherapy applicator geometries. For sources contained inside the applicators or shields 2701, ray tracing 2702 may be performed on a surface geometry representation 2703 of the applicator and shields, until the ray trace crosses the external surface of the applicator 2704. The ray tracing is then continued through the ray trace voxel grid 2705. If a second applicator is in the path of the ray trace, the ray trace will continue through the second applicator/shield surface geometry. In this manner, ray tracing is performed on the ray trace voxel grid, except when the ray trace traverses an applicator geometry.

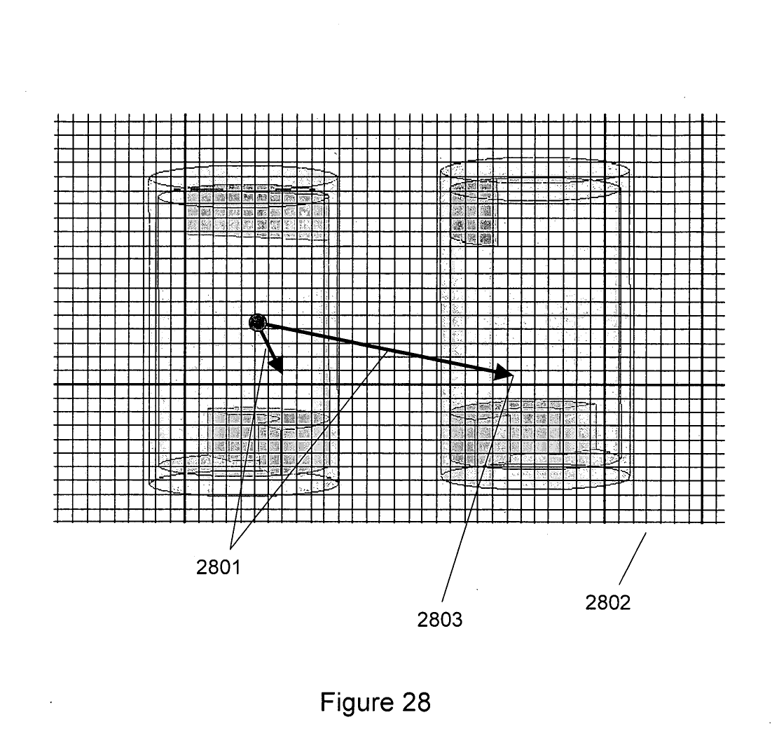

FIG. 28 shows ray tracing to voxels internal to the brachytherapy applicators for calculating the first scattered photon source in those voxels. Since scattering inside the applicators can influence the dose field, it may also be necessary to calculate the first scattered-photon source for ray-trace-grid voxels located within the applicator geometry. Ray tracing 2801 may be performed to all voxels in the ray-tracing grid 2802, including those interior to, or overlapping, the applicator or shield geometry. For voxels located internally to the applicator or shield geometry 2803, the first scattering source may be computed using the material corresponding to the geometry for which the center of that voxel is located. Alternatively, a more complex averaging method may be employed, in which the material properties in each ray trace grid voxel may be calculated using a more advanced volume-averaging-based method.

The photon-transport calculation may then be performed on a coarser photon-transport grid, where material properties of the photon-transport grid for elements inside or overlapping applicator or shield geometries are calculated from either the acquired image pixel materials, or modified image pixel materials with either prescribed material properties or material properties obtained from the surface geometry for which that pixel center is located.

5. Process for Pre-Calculating Radiotherapy Dose Fields

A method is presented for accurately pre-calculating the dose response at one or more points, regions, or grid elements for the purposes of external photon beam radiotherapy treatment plan optimization. In treatment planning, dozens or hundreds of dose calculations may be performed in the development of a single optimized plan. Treatment plans are generally optimized, in real-time, by a physicist sitting at the computer. To achieve clinically viable times for treatment plan optimization, therefore, dose calculations must be performed within a few seconds. Because of this, most clinical treatment planning systems in use today employ simple dose-calculation methods, such as pencil beam convolution, during treatment-plan optimization. While a more accurate method, such as convolution superposition or a Monte Carlo method, may be used for final dose verification, time constraints generally prohibit their effective use during treatment plan optimization.

With the advent of image-guided radiotherapy (IGRT), the ability now exists to optimize treatment plans at every fraction, of which there may be over twenty during a radiotherapy course. Anatomical changes between and within fractions, such as breathing, weight changes, and tumor shrinkage, can all be substantial. By imaging the patient prior to, or during, each treatment fraction, IGRT enables treatment plans to be optimized, at every fraction, to account for anatomical changes. Since the treatment planning occurs when the patient is on the table, an optimized plan must be developed within a few minutes, requiring almost real-time dose calculations.

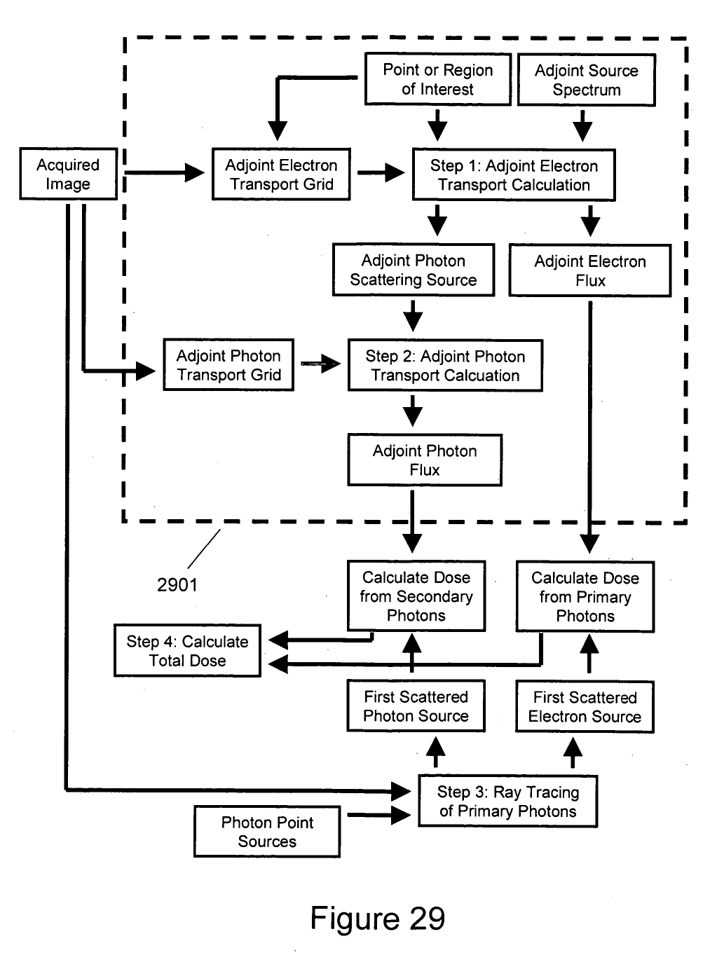

FIG. 29 shows a flow-chart describing the process for pre-calculating dose responses at prescribed locations prior to treatment planning. Steps which can be performed after a physician contours regions of interest, but prior to specification of gantry positions, are inside in the dashed box 2901.

5.1 Adjoint Electron Transport Calculations

Prior to treatment planning, a radiation oncologist will generally contour the acquired image to identify regions such as the planning treatment volume (PTV), organs at risk (OAR), and other critical structures. Specific points where the dose is of interest, or where constraints are to be applied, may also be identified 2902. This process may often be performed several days in advance of treatment planning. Through the current method, the dose response matrix for identified points and regions, or, optionally, elements in the entire anatomical region, may be calculated prior to treatment planning and prior to selection of gantry positions and photon beam delivery modality (IMRT, 3D-CRT, stereotactic radiosurgery, etc.). This is based on solving the adjoint form of the transport equations for neutral and charged particles 2904 to calculate the contribution of a primary photon at any angle, energy, and location within the anatomical region to the dose at selected points, voxels, or regions in the anatomical region.

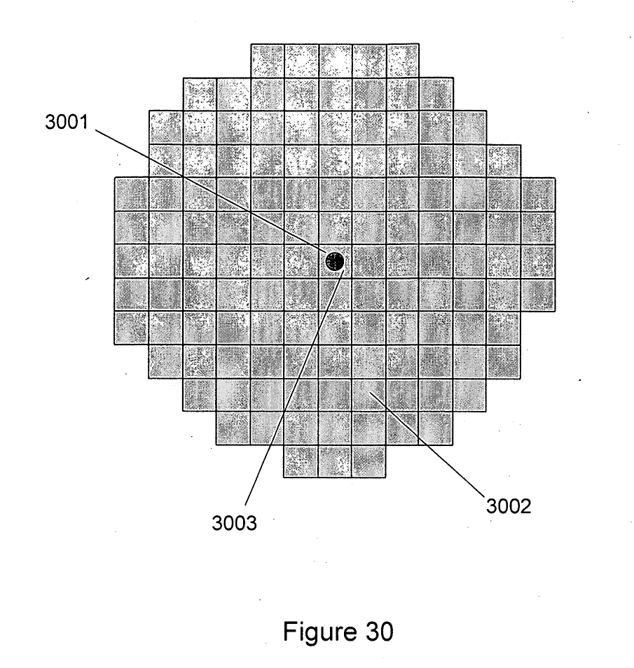

FIG. 30 shows an electron-transport grid created in the proximity of a localized adjoint source. For a selected point of interest 3001, a localized electron-transport grid 3002 is generated surrounding the point. The electron-transport-grid extents are such that the optical distance from the point to the grid perimeter is large enough so that the dose contribution of electrons beyond the grid perimeter would be insignificant to the point dose. For example, in tissue or higher density materials, a 2 cm margin around the dose point may be sufficient. The source may be modeled as a volumetric source electron source applied to a single electron-transport grid element where the point is located 3003. Local element refinement 3101, or some other form of spatial adaptation, may be performed to represent a highly localized source while minimizing the number of elements in the electron-transport grid 3102. For example, localized refinement may be performed in the element where the source is located so that the point may be represented as a volume source in a single refined element 3101. Alternatively, a spatially variable source distribution may be applied in the element having a finite-element representation, perhaps using a tri-linear discontinuous or tri-linear quadratic representation.

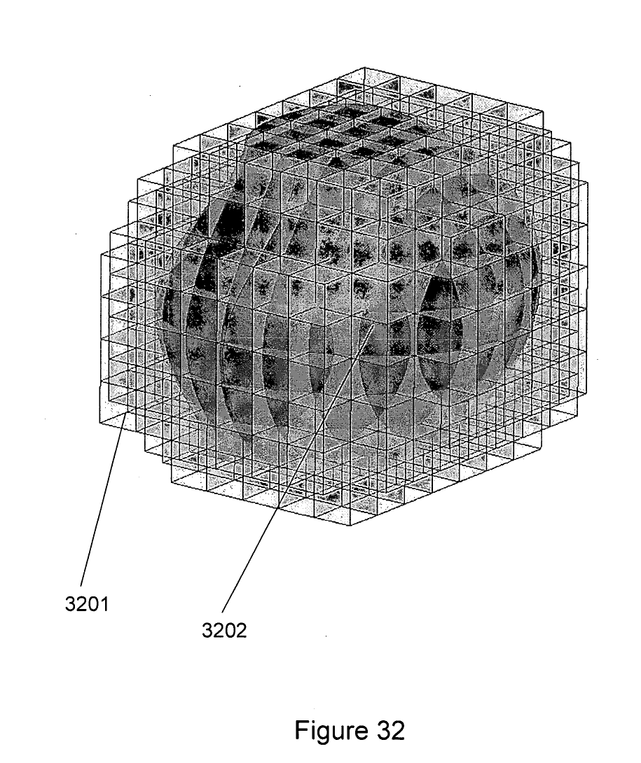

FIG. 32 shows electron-transport grid elements encompassing a region of interest for an adjoint electron transport calculation For a selected region, one of two approaches may generally be taken. If only the integrated dose to the entire region is desired, and not a distribution, an electron-transport grid 3201 can be created enclosing the entire region volume 3202. An isotropic adjoint volume source is then defined over all elements which are contained in, or overlap, the region volume. For elements that overlap the region boundary, a spatially variable source distribution may be applied. Additional element layers may be added outside of those which overlap the region perimeter, such that a buffer region is created so that electrons beyond the grid perimeter would have an insignificant dose contribution to the region.

If the dose distribution through an entire region is desired, as would be necessary for dose volume histograms, the adjoint calculation is repeated N times, where N is the number of elements contained within, and overlapping, the region. Similarly, if the dose distribution is desired through the entire anatomical region, N may be the number of electron-transport grid elements comprising the anatomical region. For each calculation, only the source element and those elements within the immediate vicinity are needed, such that the optical distance from the source to the grid perimeter is large enough so that the dose contribution of electrons beyond the grid perimeter would be insignificant to the source. A spatially variable source may be applied in those elements which overlap the region boundary, such that the source approximates the region boundary.

The calculation process for each source, whether each source is a single point, an entire region, or a single element within a region, is described as follows. An isotropic adjoint volume source, having a spectrum equal to the energy dependent electron flux-to-dose response function, for the desired dose quantity (D_{W}, D_{M}, etc.) is applied to the source element(s). An adjoint electron-transport calculation is performed on the electron-transport grid.

The adjoint electron-transport calculation will produce the adjoint electron flux 2906, as a function of electron angle and energy, at every spatial unknown in the electron-transport grid. This solution represents the contribution that an electron at any angle, energy, and location in the transport grid will have to the dose response to the adjoint source. This output may be mapped to the ray-tracing-voxel grid, and saved to disk for use during treatment planning. A second product of this calculation is the adjoint photon-scattering source 2908, which can be calculated at each ray trace voxel from the energy dependent adjoint electron flux associated with the ray trace voxel, and from the material cross sections in that voxel.

5.2 Adjoint Photon Transport Calculation

In one embodiment of the present invention, the dose obtained from secondary photons may be calculated from a KERMA approximation rather than explicitly transporting the electrons. In this manner, the adjoint photon-transport calculations 2910 are performed as follows.

A photon-transport grid is 2912 constructed, which may encompass the entire anatomical region, having a coarser element size than elements in the electron-transport grid. For example, for a ray-trace-voxel-grid size of 2×2×2 mm³ and an electron-transport grid element size of 4×4×4 mm³, a photon-transport grid voxel size of 8×8×8 mm³ may be employed. Material properties are mapped to elements in this grid. For each photon-transport grid element overlapping a region where the dose is desired, a photon adjoint source may be prescribed as an isotropic point source having a spectrum equal to the energy dependent KERMA flux-to-dose response function, for the desired dose quantity (D_{W}, D_{M}, etc.). Ray tracing from this point source may be calculated using the adjoint form of the process described in Section 1.1, to construct the first scattered adjoint photon source. The first scattered adjoint photon source is used as input to a deterministic adjoint photon-transport calculation to solve for the adjoint scattered photon flux throughout the photon-transport grid.

The primary output from this calculation is the adjoint scattered photon-flux field 2914, which may be mapped on to the ray-tracing-voxel grid, based on the tri-linear discontinuous solution representation calculated in each photon-transport grid element, and saved to disk for use during treatment planning.

5.3 Storing the Data

The above processes, described in Sections 5.1 and 5.2, may be repeated for each adjoint electron source and each adjoint photon source. When completed, the resulting matrix of adjoint calculations can be combined in a variety of manners, and can be used to reconstruct the dose at every adjoint source location resulting from the primary-photon flux at any location in the ray-tracing-voxel grid, as a function of photon angle and energy.

To this point, the adjoint calculations are independent of gantry positions and the type of photon beam therapy, and thus may be performed prior to treatment planning. To minimize reconstruction times, the data produced by the matrix of adjoint calculations may be reprocessed into a format which can be rapidly accessed for dose reconstruction during treatment planning. A variety of techniques may be employed to condense the adjoint data for storage and subsequent access time during treatment planning.

5.4 Ray Tracing of Primary Photons

After potential gantry positions are specified, which may be during or prior to treatment planning, ray tracing 2920 may be performed, using the process described in Section 1.1, to calculate the first-scattered-photon 2922 and first-scattered-electron 2924 sources at ray-tracing-grid voxels as a function of photon intensity for point source(s) at a given gantry position.

For each ray trace, the dose resulting from the first-scattered-photon and first-scattered-electron sources can be computed as follows. The energy and angular dependent first scattered-electron source in a given ray-tracing-grid voxel, calculated via ray tracing, can be multiplied by the energy and angular dependent adjoint electron flux response in that voxel, calculated in Section 5.1, for each electron adjoint source location. Similarly, the first scattered-photon source in the ray-tracing-grid voxel can be multiplied by the energy and angular dependent adjoint photon-flux response in that voxel, calculated in Section 5.2, for each photon adjoint source location.

The two dose components calculated above, including the dose 2926 resulting from the first scattered-photon source and the dose 2928 resulting from the first scattered-electron source, are summed together to compute the total dose 2930 in each adjoint source location as a function of the primary photon energy and intensity emitted from a specific photon point source being ray traced along a specific angle to a specific ray-tracing-grid voxel.

If the photon-point-source energy spectrum is assumed to be constant along a given ray trace, and does not vary between dose calculations, the dose response resulting from all energies may be collapsed into a single response function. In this manner, the dose in each adjoint source location may be stored only as a function of the primary photon intensity from a specific photon point source being ray traced along a specific angle to a specific ray-tracing-grid voxel.

In treatment plan optimization, it is common practice to represent the angular dependence of a photon source as a 2-D fluence map, where the photon source intensity does not vary continuously as a function of angle, but is represented by a finite number of discrete angular bins, perhaps defined as a 2-D grid normal to the point source direction, at some distance from the point source. All ray traces which pass through a given element on a 2-D grid may be assigned the same photon intensity. In this manner, the dose response may be further condensed such that the dose response at a given adjoint source location is summed for all ray-tracing-grid voxels located within a single 2-D grid element. Thus, the dose response at any adjoint source location is represented only as a function of the photon-source intensity at each element in 2-D grid. This information may be easily stored in memory prior to treatment planning, and used to rapidly compute the dose field resulting from each treatment plan generated during the optimization process.

In one embodiment of the present invention, the adjoint form of the last-collided flux method, described in Section 7, may be used instead of the ray-tracing process described in Section 1.1, to transport the adjoint source in the anatomical region to calculate the dose response at the point source where the treatment plan is specified. Other embodiments also exist.

5.5 Accounting for Anatomical Motion

In the course of a radiotherapy treatment, the patient anatomy may considerably vary between treatment fractions, or even within a single fraction. In such cases, the above process may be adapted to account for anatomical motion through the following steps. As described above, prior to treatment planning, the adjoint electron flux and adjoint photon flux for each adjoint source may be calculated and stored on the ray-tracing-voxel grid. This process may be performed based on the original image data. A second image is acquired, and through a registration process, the adjoint flux data can be mapped to a ray-tracing-voxel grid constructed from the second image. If motion changes are substantial, the dose may be corrected by in some manner to account for motion. A simple example of this is to introduce a correction which is based on the distance between a given ray-tracing-grid voxel and an associated adjoint source location. For example, consider the dose response at a given adjoint source location from first-scattered-photon and first-scattered-electron sources at a given ray-tracing-grid voxel. When the adjoint calculations were performed, the adjoint source and ray-tracing-grid voxel were separate by a distance of r₁. Due to motion changes, the new distance between the two is r₂. The original dose response may be then multiplied by r₁²/r₂² to account for the motion difference.

The ray tracing process is then performed on the ray-tracing-voxel grid of the second image, and the first-scattered-photon and first-scattered-electron sources, calculated by ray tracing, are generated using material properties from the ray-tracing-voxel grid of the second image.

6. Other Dose Calculation Modalities

Many of the methods described in Sections 1 through 5 can be applied towards calculating doses in other radiotherapy modalities, or for imaging. For targeted radionuclide therapies, a radioactive isotope, typically a beta emitter, is attached to a molecular targeting agent and injected into the patient. The source activity distribution may be measured by attaching a positron emitting isotope to the targeting agent, and then performing a PET scan. This may be performed prior to treatment. Thus, input to a patient dose calculation for radionuclide therapies may include: (1) a CT image, which contains structural data; (2) the PET scan, which contains the source activity distribution; and (3) the emission spectrum of the radioactive isotope, which is known. Using (2) and (3), an isotropic volume source is then generated and used as input to an electron-transport calculation, described in Section 1.3. The volumetric source may be mapped to the electron-transport grid using a spatially variable representation within each element, according to the finite-element representation used for the electron-transport calculation. A process similar to that described in Section 1.3 may be used to reduce the electron-transport-grid extents prior to the electron-transport calculation. In this manner, a minimum source activity may be prescribed, where the parameters Dₘᵢₙ and Dₘₐₓ may be based on the source activity magnitude in each element as obtained from the PET scan. The process described in Section 1.4 may then used to calculate the patient dose.

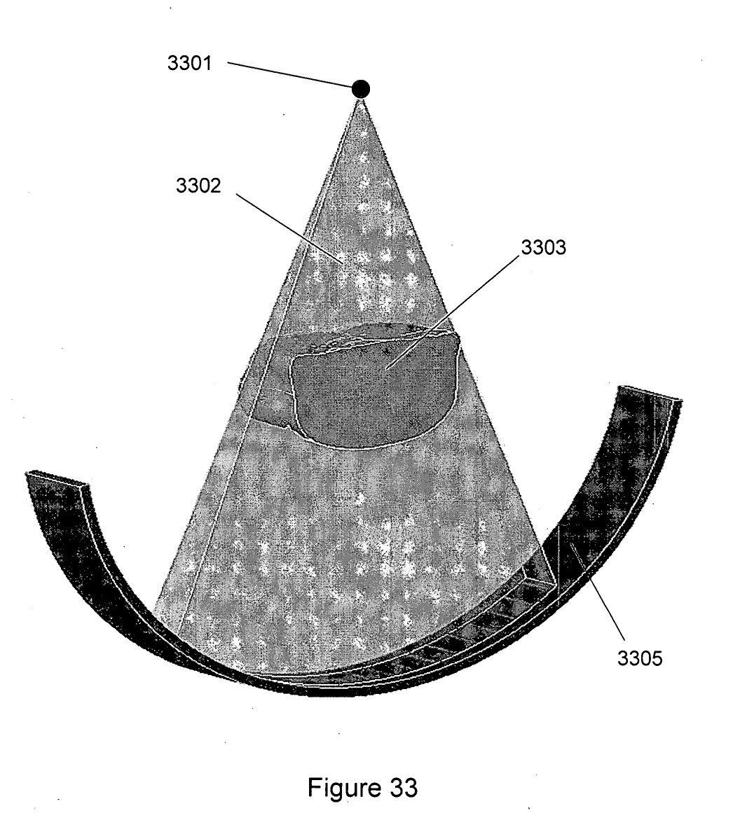

FIG. 33 shows an example computed tomography beam passing through an anatomical region and out to a detector array. For dose calculations from CT imaging and radiography procedures, a process similar to that described in Sections 1.1 and 1.2 may be employed. In CT imaging, a localized external photon source 3301 is collimated to a fan or cone beam profile 3302, which is projected on to an anatomical region 3303. An array of detectors 3305 is situated opposite the anatomical region, which measures the photons reaching the detectors. Since photon energies typical of imaging are much lower than that of external photon beam radiotherapies, the spatial transport of electrons may be neglected and dose may be obtained through a KERMA response. This process may be similar to that described in Section 4 for brachytherapy, where the primary dose may be computed directly at each ray-tracing-grid voxel using KERMA, and a group photon-transport calculation is performed to compute the scattered dose separately. Other imaging and radiotherapy modalities may use other combinations of the methods described herein.

7. Imaging Scatter Prediction

In imaging modalities such as CT, radiography, PET, and SPECT, image scatter may reduce image quality, and the accurate prediction of image scatter can either improve quality by subtracting the scatter component off prior to reconstruction, or by explicitly using the scattered signal in the reconstruction process. A method is presented for calculating the scattered radiation reaching detectors for imaging modalities. Although the process is specifically outlined for CT imaging, various embodiments of it can be applied towards other imaging modalities.

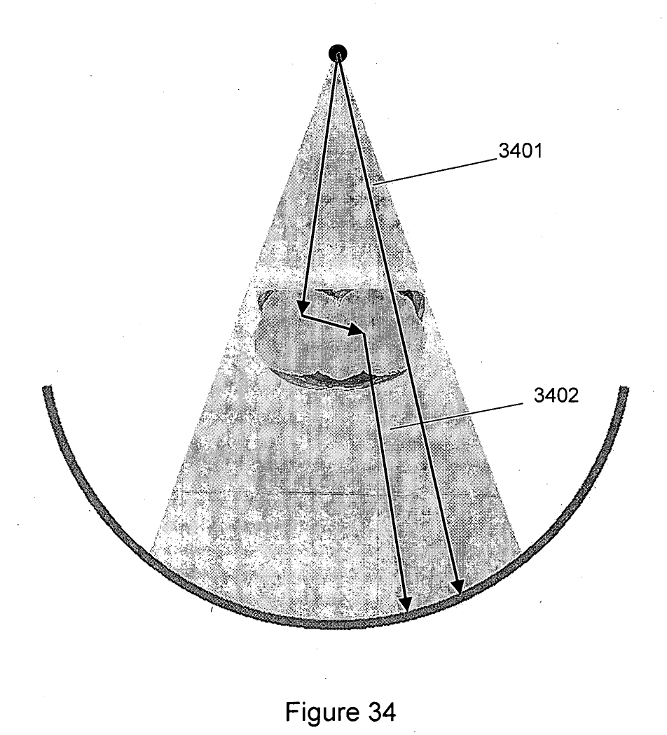

FIG. 34 shows an example of relevant photon interactions occurring inside an anatomical region for computed tomography imaging. In CT imaging, image reconstruction is desired to be performed using only the signal produced by photons 3401 that reach the detectors without scattering. To achieve this, the contribution of scattered photons 3402 in the anatomical region which reach the detectors needs to be calculated.

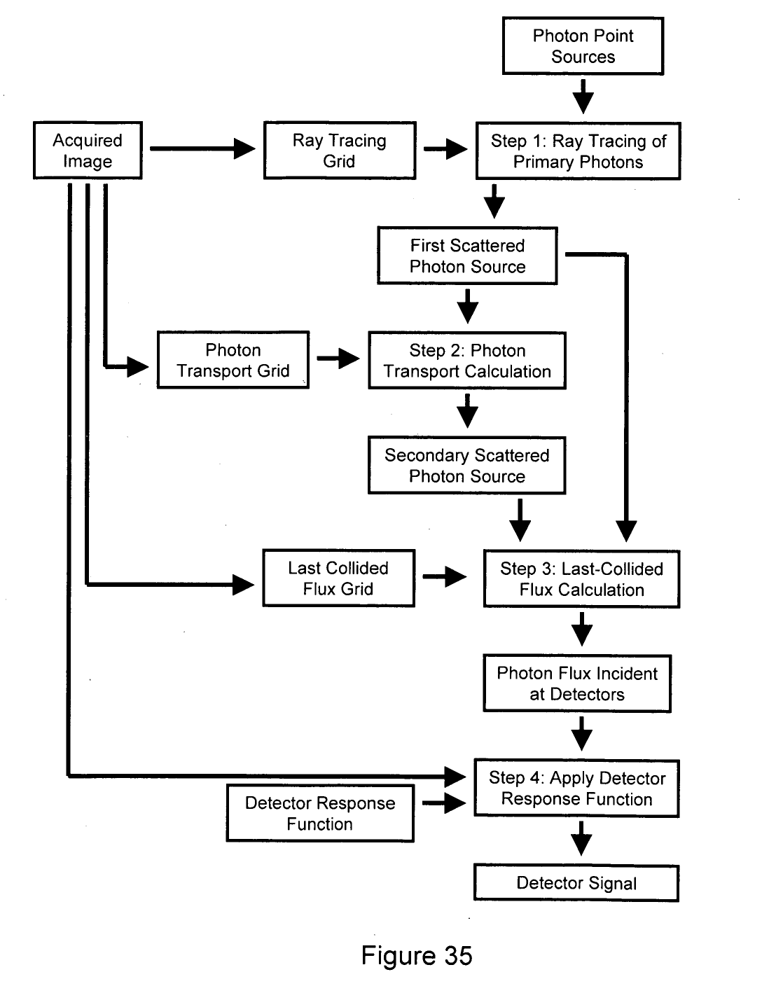

FIG. 35 shows a flow chart of the calculation process for predicting image scatter in computed tomography. As outlined in FIG. 35, the process for calculating the image scatter separate steps may be performed in 4 steps: (1) transport of primary photon source into the anatomical region 3502, (2) calculation of the scattered photon field within the anatomical region 3504, (3) transport of the scattered photons from within the anatomical region to external detectors 3506, and (4) application of a detector response function 3508 to convert the angular and energy photon distribution incident on the detectors to a detector response. Steps (1) and (2) can be performed in a manner similar to that described in Sections 1.1 and 1.2 for external photon beam dose calculations. Step (3) is performed through a separate process described below.

A separate method is used to transport the scattered photons from the anatomical region to external detectors. This is referred to as the “last-collided flux” method. The last-collided flux method provides an accurate description of the solution to the LBTE at any point, internal or external to the anatomical region, by tracing along a direct line of sight back from the point in question to known source terms in the problem while accounting for absorption and scattering in the intervening media. In the case of exactly known sources and material properties, the solution is exact. This technique is a novel application of the integral form of the LBTE, given by:

$$Ψ ( \vec{r} , \hat{Ω} ) = {\int }_{0}^{R} \{ q ( \vec{r} - {R}^{′} {Ω}^{′} , \hat{Ω} ) {ⅇ}^{- τ} + Ψ ( \vec{r} - R {Ω}^{′} , \hat{Ω} ) {ⅇ}^{- τ} \} ⅆ {R}^{′} , \qquad ( 23 )$$

where q=q^{scat}+q^{ex}, the optical path r is defined as:

$$τ = {\int }_{0}^{{R}^{′}} {σ}_{t} ( \vec{r} - {R}^{″} , \hat{Ω} ) ⅆ {R}^{″} , \qquad ( 24 )$$

and R is a distance upstream from \vec{r} in the direction −\hat{Ω}. The term on the right in the integrand of Equation (23) represents the un-collided contribution to Ψ at \vec{r} from the flux at point \vec{r}−R\hat{Ω}, the upper limit of the integration path. The term on the left in the integrand represents the contribution to Ψ at \vec{r} from scattering and fixed sources at all points along the integration path between 0 and R.

Equation (23) represents the angular flux, Ψ..as a line integral from 0 to R upstream back along the particle flight path, \hat{Ω}. The method described herein consists of a discretized version of this line integral obtained by imposing a discrete computational mesh encompassing the scattering region and evaluating the problem material properties and source terms on this mesh. The method is general and can be applied independent of the mesh type and the means of source term evaluation. The method is used to transport volumetric source terms to locations either internal or external to the computational mesh. Input to the last-collided flux process includes both the problem material representation and the volumetric source description. The problem material representation may be the ray-tracing-voxel grid, the photon-transport grid, or another representation such as an unstructured computational mesh. The source terms include both fixed and calculated scattering source terms. For CT imaging and radiography, the fixed source term may be the first scattered-photon source, calculated in Step (1) 3502, and used as input to the photon-transport calculation, performed in Step (2) 3504. For PET or SPECT imaging, the fixed source term is the prescribed input, which is obtained from a prior PET/SPECT image reconstruction. A discretized version of the line integral given in Equation (23) is then performed to produce calculate the particle flux at desired points, which may be external to the anatomical region in medical imaging.

Although the last-collided flux method in general imposes no restriction on mesh type or the means of scattering source term calculation, the method is described here using a three dimensional linear tetrahedral finite element mesh. One embodiment is to calculate the scattering source term using a discrete-ordinates solver based on a linear or higher order discontinuous spatial trial space. Other mesh types and means of source term calculation could be employed, if desired. Although energy dependence and anisotropic scattering are suppressed in this description in the interest of brevity and clarity, the method described here can easily accommodate these effects.

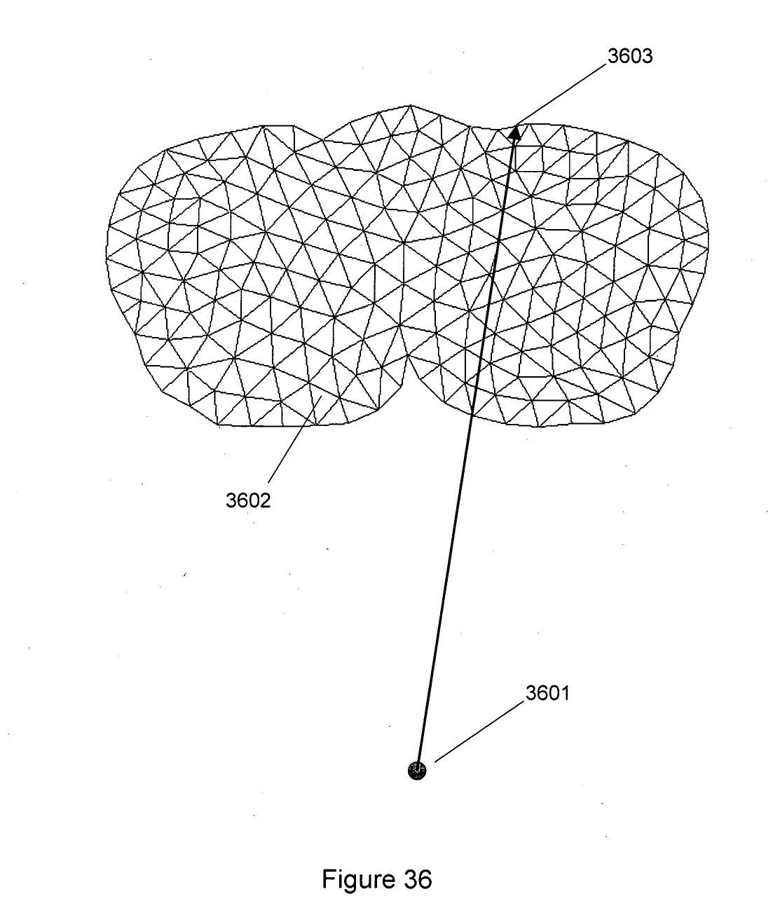

FIG. 36 shows a ray trace, as part of the last-collided flux method, from a detector point through a computational mesh of the anatomical region to compute the photon scatter reaching that detector point along the direction of the ray. For the chosen mesh and spatial discretization, the source terms for the line integration are provided as linear discontinuous functions on each mesh cell and the material properties for absorption and scattering are tabulated as piecewise constant functions on each mesh cell. The line integration is performed using an analytic ray tracing technique that evaluates the line integrals by proceeding step-wise cell-by-cell through the computational mesh, accumulating the result as the process proceeds. For computational convenience, the line integral begins at the evaluation point r 3601, passes through the computational mesh 3602, and terminates at end-point R 3603 at the problem boundary. The number and direction of line integrals is arbitrary and can be specified on a per problem basis to provide the desired level of angular resolution and enhance the quality of the results. Each line integral is evaluated as the sum of contributions from individual elements that the line passes through. These elements are discovered by a simple ray-tracing method which computes the entering and exiting face coordinates on each element as well the distance δr between these two points. Many other methods could be employed. On an individual element, the optical path, τ, is computed as the distance σ_{τ}δr where σ_{τ} is the total cross section on the element. The values of the source, which are provided at the unknown flux locations by the deterministic solver, are then projected to the entering and exiting face points as the weighted sum of the appropriate face vertex source values using standard finite element formulas Given the source terms at the entering or upstream (qᵢ₊₁) and exiting or downstream (qᵢ) face points, a formula for the contribution to the line integral from the fraction of the line integral associated with any particular element can be produced by analytic evaluation of the first term in Equation (23). This results in the following formula:

$${\int }_{R}^{{R}_{i + 1}} ( . ) ⅆ R = \frac{δ r {ⅇ}^{– \sum τ}}{{t}^{2}} ( {q}_{i + 1} ( 1 - {ⅇ}^{τ} ) τ + ( {q}_{i} - {q}_{i + 1} ) ( - 1 + ( 1 + τ ) {ⅇ}^{τ} ) ) , \qquad ( 25 )$$

where Στ is the total optical path from 0 to Rᵢ. For computational convenience, the path begins the integration at r and traverses the elements in the \hat{Ω} direction out to the most distant problem boundary. The total line integral is then trivially computed as the sum of the contributions from each individual element. Thus, i in Equation (23) runs from zero to the number of elements in the line and Στ is the sum of the individual τ's from R₀ to Rᵢ. If the total cross section on a cell is zero, that is τ=0, then the following formula is used in lieu of Equation (25):

$${\int }_{R}^{{R}_{i + 1}} ( . ) ⅆ R = \frac{δ r {ⅇ}^{– \sum τ}}{2} ( 3 {q}_{i + 1} - {q}_{i} ) , \qquad ( 26 )$$

where q in this case consists of simply the fixed source. At the boundary of the problem, any boundary source is accommodated by the addition of the analytic integral of the last term in Equation (23), which evaluates to:
Ψ_{b}e^{-Στ}, (27)
where Ψ_{b} is the value of the boundary source. This procedure described above is repeated for each line integral in the problem.

For cases where the angle integrated flux is used, the analytic angular integral employs an infinite number of directions to be evaluated. In this method, a discretized version of the angular integral is computed as a weighted quadrature sum of all the available individual line integrals.

Although a preferred embodiment is for the last-collided flux to use a spherical harmonics source representation as input, it is generally applicable, and could easily be adapted to use a discrete angular representation of the scattering source. In another embodiment of the present invention, the scattering source in each element may be represented as one or more anisotropic point sources, which can be ray traced to each detector point through the process described in Section 1.1.

This method is useful in a broad range of applications including: transporting the radiation flux to detectors for image scatter predictions; resolving streaming paths for shielding calculations; and calculating the angular flux distribution at any location for angles other than those solved for in a deterministic transport calculation.

A principal benefit of this approach is that the angular resolution (angular quadrature order, also referred to as S_{N} order) used in the deterministic transport calculation can be driven by the need to resolve the scattering solution in the transport grid, which may be much lower than that required to transport scattered particles over large distances in low-scattering media, such as voids, air, or streaming paths. Secondly, this approach may also eliminate the need to have a computational grid constructed in an intervening low-scattering medium simply to transport a scattering solution to external points of interest. In cases such as the above, memory and run-time restraints are such that normal solution techniques at a desired resolution are completely impractical, and the last-collided flux method described herein becomes an enabling technology.

For image reconstruction, this method can be used to efficiently and accurately calculate the angular and energy dependent particle flux incident on detectors far away from the anatomical region. For each detector, the angles for which the last-collided flux is computed may be varied, to account for the detector specific orientation and collimation. Similarly, varying weights may be associated with each angle and energy in the last-collided flux calculation, to allow for the application of angle and energy dependent response functions.

The last-collided flux method may be calculated on a different grid than that used to compute the scattering source. For example, in imaging the photon-transport grid may be used to compute the scattering source. The prescribed and scattered sources may then be mapped over to a finer resolution grid, such as the ray-tracing grid, or an alternative coarser grid, which is used for the last-collided flux calculation.

8. Treatment Head Modeling

In external photon beam radiotherapy, particle scattering through field-shaping devices such as jaws 104, wedges, and collimators 105, may substantially influence the radiation field delivered to the anatomical region. The present invention provides a method for transporting a radiation source through patient dependent field-shaping devices to create focal and extra-focal sources, representing the primary and secondary radiation fields, respectively, exiting the treatment head, which may be used as input to a radiotherapy dose calculation.

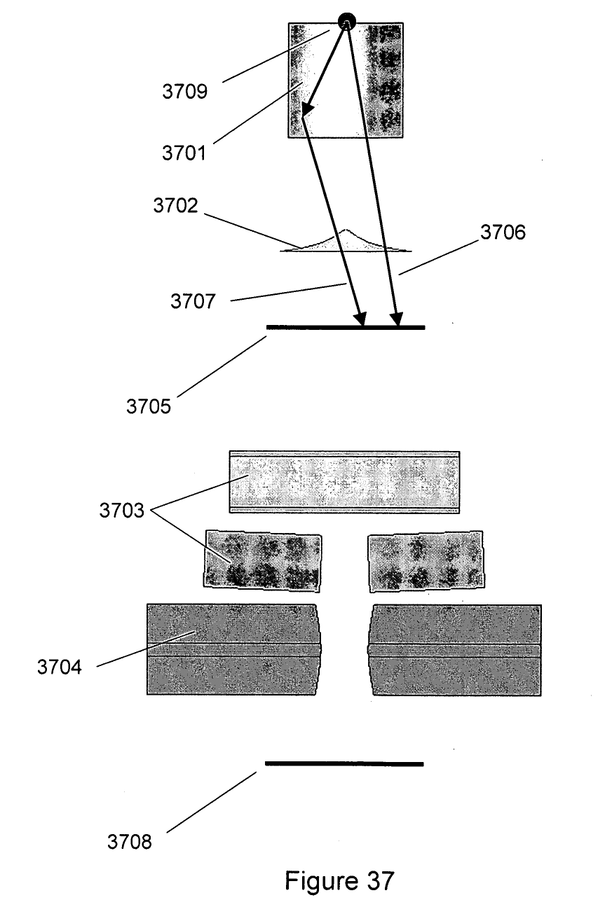

FIG. 37 shows relevant field shaping components of a linear accelerator, along with examples of photon interactions in the patient-independent field-shaping components. The field shaping components of a linear accelerator may be grouped into one of two categories: (1) patient-independent field-shaping devices refer to those which are fixed and are generally not modified for patient specific treatments, which may include the primary collimator 3701 and flattening filter 3702; and (2) patient-dependent field-shaping devices refer to those which may be modified to create conformal fields for patient specific treatments, which may include jaws 3703, blocks or wedges, and a multi-leaf collimator 3704.

It is common practice in radiotherapy to create a source description which describes the photon, and possibly electron, source at a plane 3705 below the patient independent components. This source description may be represented as a model consisting of three components: (1) a focal photon source which represents the distribution of primary, or unscattered, photons 3706 on the source plane 3705; (2) an extra-focal photon scattering source, which represents the scattered photon distribution 3707 on the source plane 3705; and (3) an electron source, which represents the electron distribution on the source plane. Sources (1), (2), and (3) are referred to as the accelerator focal source, accelerator extra-focal source, and the accelerator electron source, respectively.

A process is described transporting particles through the patient dependent field-shaping devices, using the accelerator sources as input, and creating a patient dependent source model, which represents the photon, and optionally electron, particle distribution at a location below the treatment head exit 3708. In one embodiment of the present invention, this source model may be represented as three components: (1) a focal photon source which represents the primary photon distribution, (2) an extra-focal photon source representing the scattered photon distribution, and (3) an extra-focal electron source representing the electron distribution. Hereafter, sources (1), (2), and (3) are referred to as the patient focal source, patient extra-focal source, and the patient electron source, respectively.

The process described below is for the calculation of the three patient sources for a single field position, of which for IMRT there may be numerous field positions comprising a single gantry position. In dynamic IMRT or other modalities where the field-shaping devices are in continuous motion, the time integrated field shape may be represented by a number of discrete field positions. In a preferred embodiment, the sources calculated from each field position in a single gantry position will be time weighted to create a single patient focal source, a single patient extra-focal source, and a single patient electron source, respectively, for each gantry position.

8.1 Calculating the Patient Focal Source

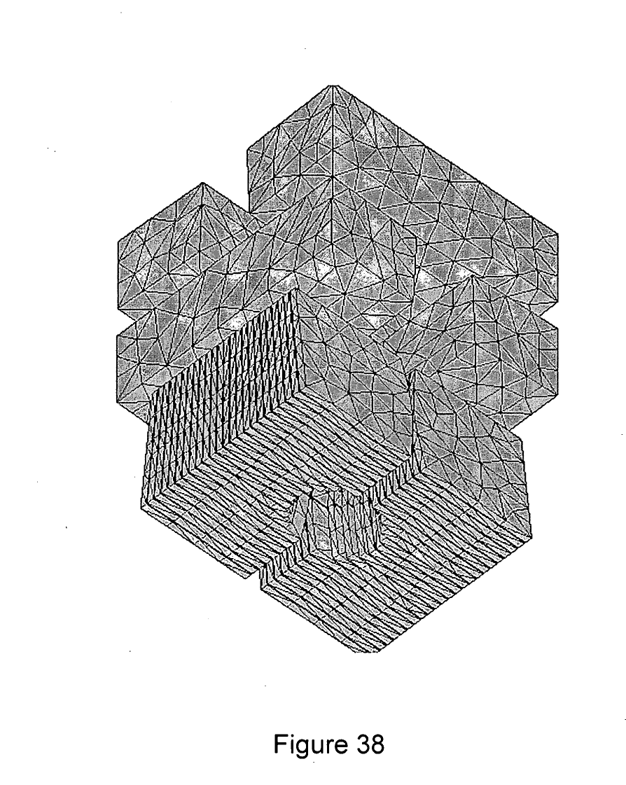

The patient focal source may be represented as a photon point source which is anisotropic in angle and energy, and located at the accelerator target 3709. The process for creating this for a single field is as follows: A geometric model is constructed for each of the relevant patient-dependent field-shaping components, which will generally include jaws, wedges, multi-leaf collimators, and any other components which may substantially influence the radiation field exiting the treatment head. FIG. 38 shows separate computational meshes constructed on relevant patient-dependent field-shaping components. The geometric models can be in any number of formats, including analytic planar and spline based surfaces, faceted surfaces, or body fitted computational meshes as shown in FIG. 38. Material properties are assigned to each component.

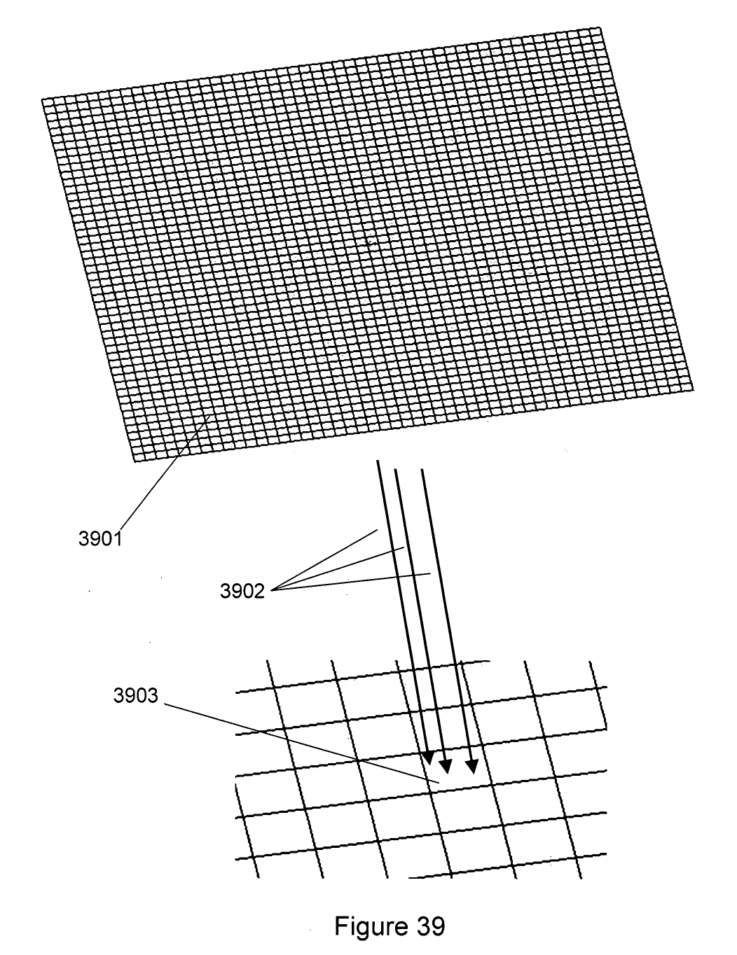

FIG. 39 shows a 2-D grid used to score the primary photon flux exiting the patient-specific field-shaping devices. A grid 3901 is defined on the plane below the treatment head exit where the primary-photon flux distribution will be calculated. The grid density may control the resolution of the patient focal source. For example, if a grid density of 2×2 mm² is specified, the photon intensity and spectrum in the patient focal source may be constant for all ray traces 3902 from the focal point proceeding through a single grid element 3903.

For a given field position, the geometry models of the field shaping components are translated to their respective positions. The primary-photon flux may be calculated at each grid element by ray tracing to the center of each grid element using the process described in Section 1.1. In one embodiment of the present invention, the ray tracing may be performed at a resolution finer than that of the grid, and the primary flux in each grid element may be obtained by averaging the primary flux calculated for all locations inside that grid element.

8.2 Process for Creating the Patient Extra Focal Source

The process described here is a method to calculate the extra-focal source, either at a plane below the treatment head exit or at the photon-transport grid boundaries. Separate, body fitted computational grids are constructed on each relevant field shaping component. The grids may be of a variety of element types, including tetrahedral and hexahedral elements. The mesh in each component is created independently, where every node and face are associated with elements of only a single component. In this manner, each component grid can be rotated and/or translated independently of all other components. A mesh is not generated in the surrounding air. Since a separate grid is created on each component, it is independent of any treatment plan, and thus the grid generation needs only to be performed once for each component, and can be done prior to treatment planning. Material properties are assigned to each element according to the component properties which that element resides in.

Using the process in Section 1.1, ray tracing is performed from the accelerator focal source into the computational mesh of the field shaping components to construct the fist scattered-photon source in the field shaping components. In one embodiment of the present invention, the extra-focal accelerator source may be represented as a plurality of point sources, located on the plane below the patient-independent field-shaping components. In this embodiment, ray tracing may also be performed from each of these points into the computational mesh of the field shaping components.

Ray tracing may be performed to multiple points within each element of the component grid, so that a linear or higher order finite-element representation of the scattering source may be constructed in each element. Many embodiments of this process exist. For example, the optical depth in ray tracing may be calculated using a surface based representation of the components, and ray tracing may be performed uniformly or variably spaced points or elements inside the field shaping components.

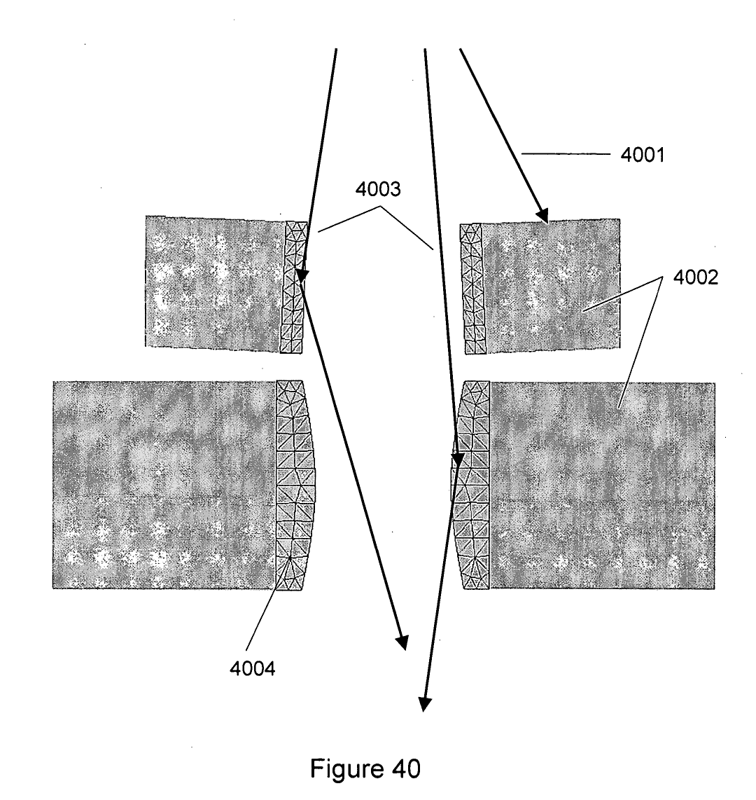

FIG. 40 shows photons scattering through patient-dependent field-shaping components, where computational grids are only created in regions where scattered photons have a high probability of passing into the anatomical region. A significant computational speed-up can be achieved by ray tracing only to those elements in the computational grid for which photon scattering would significantly contribute to the patient extra-focal source. For example, photons 4001 which scatter on the field shaping components 4002 far away from the field opening would be unlikely to pass through to the anatomical region. However, photons 4003 which scatter near the jaw openings or MLC leaf tips have a higher probability of reaching the anatomical region. Thus, the ray tracing time may be significantly reduced if the ray tracing was only performed to a subset of elements 4004 located near the beam path. Other embodiments for this exist, such as only creating a computational mesh in component regions near the beam path, and using a surface based representation for ray tracing in the remaining component volume of each component where a mesh is not constructed.

The output of this above process is a single first scattered-photon source distribution in the computational grid elements to where ray tracing is performed. The last-collided flux method, described in Section 7, may then be used to calculate the angular and energy dependent photon flux at locations either on a plane below the field-shaping devices 4101, or directly on boundary faces of the photon-transport grid 4102. Through this process, multiple photon scattering events are assumed to be negligible, and only the first scattered photons are calculated below the treatment head.

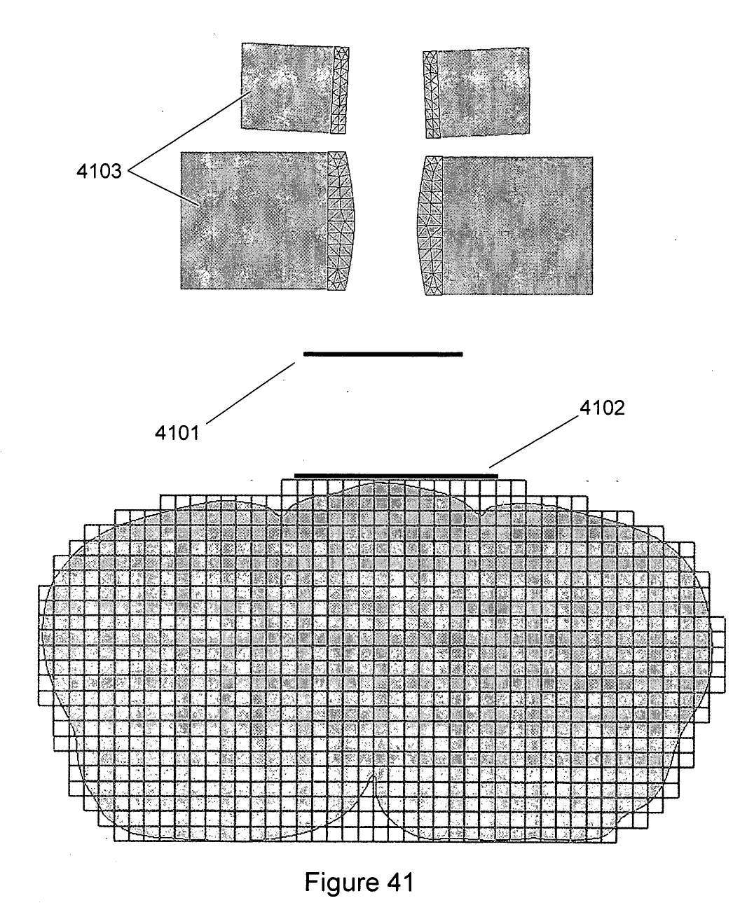

FIG. 41 shows two locations where the scattered photon field exiting the treatment head may be calculated, either at a plane below the treatment head exit, or at the boundary of the photon transport grid. If the last-collided flux method is used to calculate the energy and angular dependent photon flux on a plane 4101 below the field-shaping devices 4103, a grid may be defined as was done for ray tracing of the primary component 3901. However, since spatial variations in the scattered photon field may be more gradual than that of the primary field, a coarser grid size may be used, for example 5×5 mm². The last-collided flux method may then be used to calculate the energy and angular dependent photon flux at each grid element 4201 in the grid 4202 below the field-shaping devices, where ray tracing 4203 is performed from the center point of each grid element through the computational elements 4204 in the field-shaping devices.

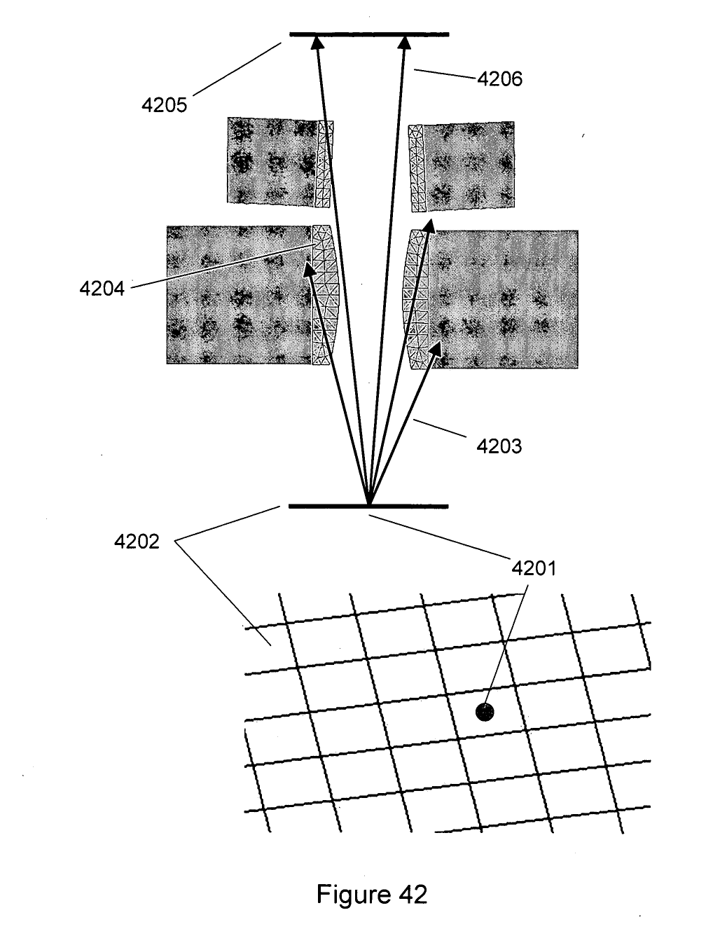

FIG. 42 shows ray tracing, using the last-collided flux method, through the patient-dependent field-shaping components and up to the patient independent extra-focal source, to calculate the scattered photons reaching the plane where the extra focal source is calculated below the treatment head exit. In one embodiment of the present invention, the accelerator extra-focal source, located on a plane 4205 above the patient-dependent field-shaping components, may be represented as a boundary source, where angular dependence is represented through spherical harmonics moments, and spatial variations are represented through a 2-D element grid. In such cases, ray tracing may be performed up to the boundary source 4206, and the second term of Equation (23) can be used to perform the last-collided flux calculation from boundary sources. This process would only be necessary if the accelerator extra-focal source was not represented as a plurality of point sources, which were ray traced through the field shaping components in Section 8.2.

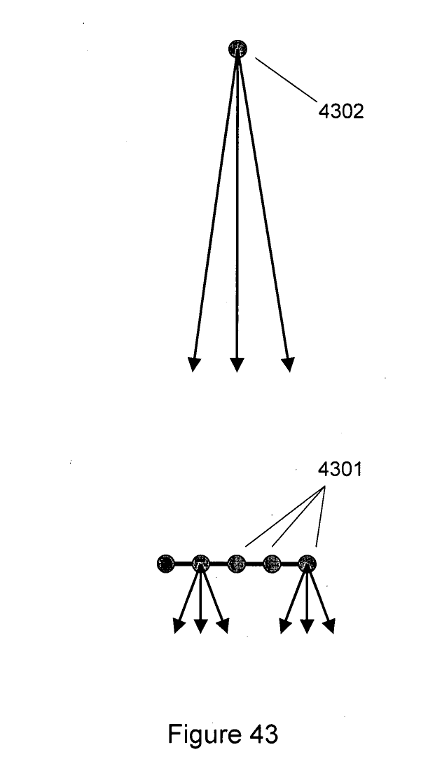

FIG. 43 shows point sources representing focal and extra focal photon sources. If the angular and energy dependent photon flux is computed on a grid below the field-shaping devices, this may be represented as a source term to the patient dose calculation in several ways. In one embodiment of the present invention, a plurality of point sources 4301 may be applied on the plane below the field-shaping devices. In another embodiment of the present invention, the scattered source may be represented as one or more point sources positioned at on the plane below the patient independent components of the field-shaping devices. In such a manner, the total photon source exiting the treatment head would consist of a patient focal source 4302, calculated in Section 8.2, and the patient extra-focal source would be represented by one or more point sources 4301. Ray tracing of each source into the anatomical region would be performed using the process in Section 1.1. In another embodiment of the present invention, the scattered photon flux calculated on the plane below the field-shaping devices may be used to modify the intensity and spectrum of the patient focal source, such that the total primary and scattered-photon sources are represented by a single point source. In another embodiment of the present invention, a method may be employed to transform the angular and energy dependent photon source on the plane below the field-shaping devices, to form a boundary source on the photon-transport grid over the anatomical region.

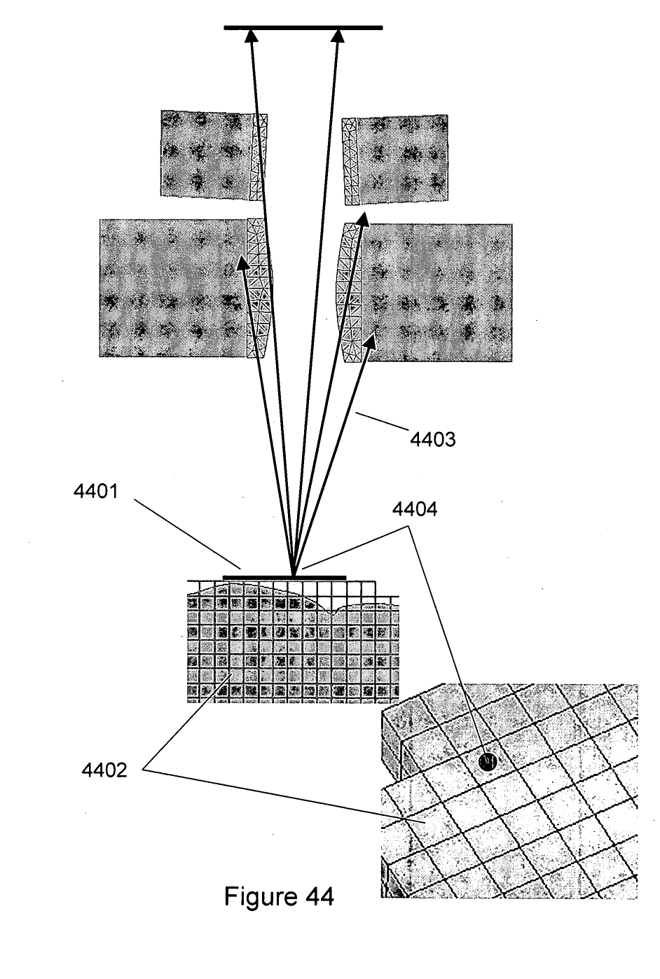

FIG. 44 shows ray tracing, using the last-collided flux method, through the patient-dependent field-shaping components, and up to the patient independent extra-focal source, to calculate the scattered photons reaching the perimeter of the photon transport grid. In another embodiment of the present invention, the last-collided flux method may be used to calculate the angular and energy dependent photon flux at the boundary 4401 of the photon-transport grid 4402. In this manner, the last-collided flux method 4403 may be used to calculate the angular and energy dependent scattered photon flux at the center of each photon-transport grid element boundary face 4404 located within the beam path, or in the region where the photon source is significant as defined by a predetermined threshold. The photon flux on each boundary face may then be converted to a boundary source, used as input to the photon-transport calculation in Section 1.2. In this manner, the patient focal source is represented as a single point source, which is ray traced into the anatomical region using the process in Section 1.1, and the patient extra-focal source is represented as a boundary source, used as input, along with the first scattered-photon source calculated in Section 1.1, to the photon-transport calculation in Section 1.2.

8.3 Process for Creating the Patient Electron Source

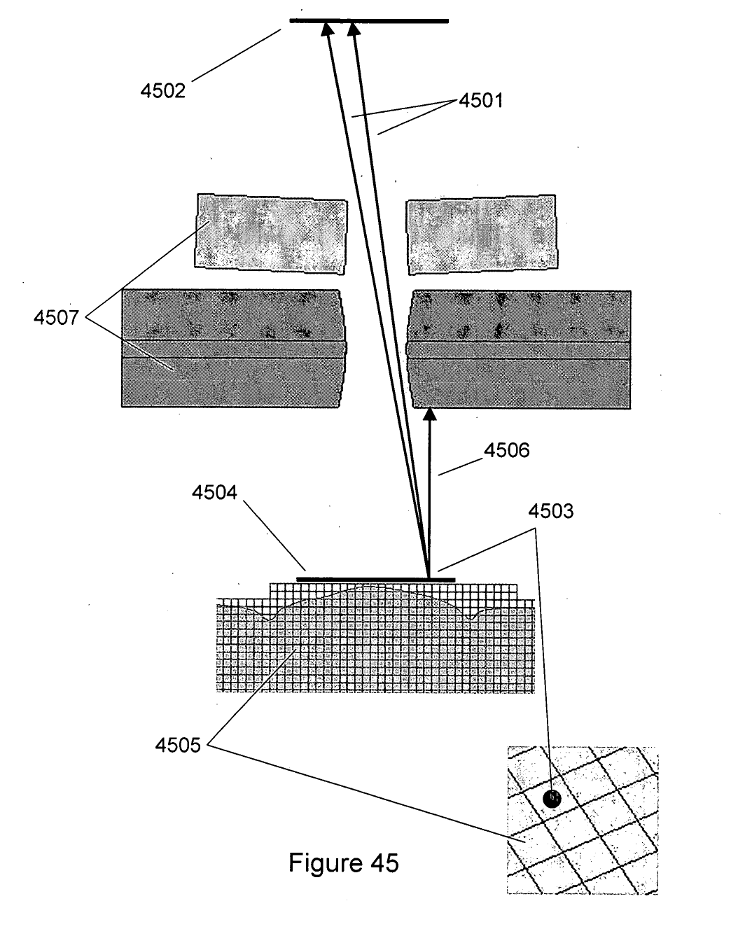

FIG. 45 shows ray tracing, using the last-collided flux method, up to the patient-independent electron-source plane to calculate electrons from this source plane reaching the perimeter of the electron transport grid. Various embodiments in the above process may be employed for constructing the patient electron source from the accelerator electron source. In one embodiment of the present invention, a variation of the last-collided flux method, adapted for charged particle transport, may be used to ray-trace 4501 the accelerator electron source 4502 represented as a boundary source, and calculate the angular and energy dependent electron flux at the center 4503 of each electron-transport grid element boundary face 4504 of the electron-transport grid 4505 located within the beam path, or in the region where the electron source is significant as defined by a predetermined threshold. The electron flux on each boundary face may then be converted to a boundary source, used as input to the electron-transport calculation in Section 1.3. This process may be performed such that for any ray-trace 4506 that crosses through a field shaping component 4507, the electron flux is set to zero. As an alternative to explicitly accounting for the continuous slowing down term in the charged particle transport equation, a simpler approximation may be implemented to determine the electron dependent electron flux for a given boundary source spectrum and intensity, and distance through the intervening air.

8.4 Alternative Embodiments

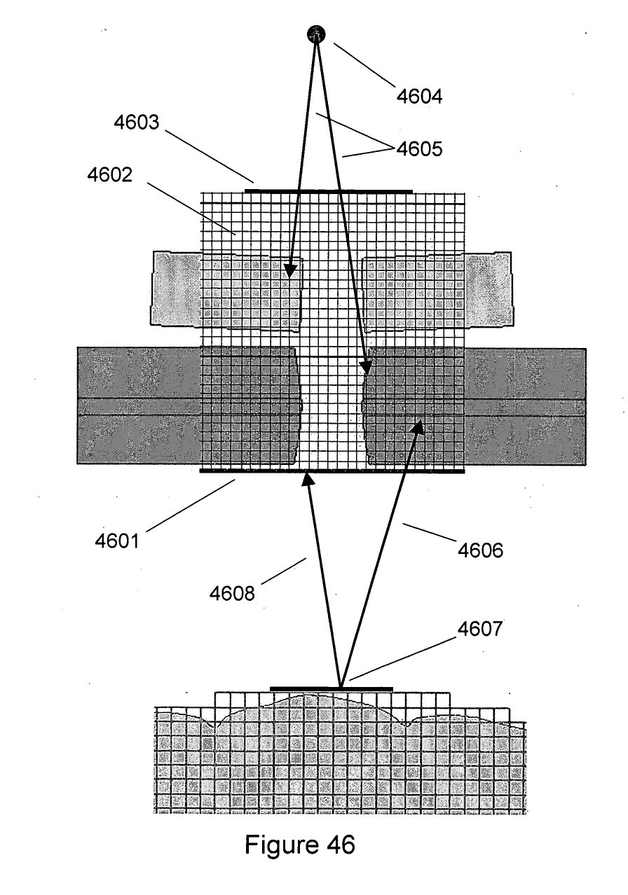

FIG. 46 shows a computational grid constructed over the patient-independent field-shaping components to calculate the scattered photon field in the computational grid resulting from multiple scattering events. In one embodiment of the present invention, the ray-tracing process described in Section 8.1 to calculate the primary-photon flux on the grid below the treatment head exit 4601 from the accelerator focal source may be performed prior to treatment planning, and stored to disk. In many cases, each ray trace will only pass through a single collimator leaf component, and thus the photon flux at each grid location may be represented as a function of the position of the collimator leaf which that ray trace passes through. In one embodiment of the present invention, if the ray trace passes through any of the jaw components, the photon flux may zeroed out for that ray trace. In this manner, the effect of jaw position(s) may also be pre-computed. A similar process may also be used to pre-calculate the first scattered-photon source in each element, which is calculated in Section 8.2 as part of the process to compute the patient extra-focal source. By employing this process, pre-calculated values can be loaded into memory prior to treatment planning, accelerating the process for creating the patient focal and patient extra-focal sources.

In another embodiment of the present invention, a deterministic photon-transport calculation may be performed to generate a patient extra-focal source which accounts for multiple photon scattering events. A computational grid 4602 may be constructed spanning the region from the plane 4603 where an accelerator extra-focal source may be specified to the plane below the treatment head exit 4601. Cartesian elements may be used, where grid lines may align with boundaries of field shaping components where possible. Variable grid spacing may be employed, and the external grid boundaries may be defined so as to minimize the number of elements by only including elements in regions which may substantially contribute to the scattered photon flux exiting the treatment head. The grid of elements may be constructed such that each element encompasses no more than one independent field shaping component, and a single computational grid may be used for all field positions, where varying component positions are represented by modifying the material properties in each element according to the fraction of the element occupied by a component for that field position. For elements which partially overlap field shaping components, spatially variable material properties may be applied in each element.

The relationship between the material properties at each spatial unknown as a function of component position, for the component(s) which overlap the element of the unknown flux location of interest, may be pre-calculated and stored in memory during dose calculations.

As was performed in Section 8.1, the accelerator focal source 4604 may be ray-traced 4605 into the computational grid to calculate the first-scattered-photon source in computational grid elements overlapping components. Ray tracing to elements only overlapping air may be neglected due to minimal scattering in the air.

Ray tracing may be performed on the surface representation used for ray tracing in Section 8.1, rather than the Cartesian computational grid. Similarly, if the accelerator extra-focal source is represented as a plurality of point sources, ray-tracing of the point sources defining the accelerator extra-focal source into the computational grid may also be performed. The output of this process may be a single first scattered-photon source distribution in the computational grid produced by the accelerator focal source, and where applicable, the accelerator extra-focal source.

A deterministic photon-transport calculation may then be performed on the computational grid, using the first-scattered-photon source as input. The accelerator extra-focal source may be applied as a spatially distributed boundary source on the plane where the source is specified 4603. If the accelerator extra-focal source was represented as a plurality of point sources, the spatially distributed boundary source is not applied.

The output of the deterministic photon-transport calculation may be used to calculate the patient extra-focal source for that field position. Numerous methods may be employed for this, some of which were described in Section 8.2. In one embodiment of the present invention, the last-collided flux method may be used to calculate, via ray-tracing into the computational grid of the field-shaping devices 4606, the angular and energy dependent photon flux at boundary faces 4607 on the photon-transport grid, and used to create a boundary source as input to the photon-transport calculation in Section 1.2. Alternatively, a boundary source may be constructed at the bottom 4601 of the computational grid, and the last-collided flux ray-tracing may be performed to this boundary source 4608. In another embodiment of the present invention, the patient extra-focal source may be represented by a plurality of point sources located at the bottom 4601 of the computational grid.

What is claimed is:

1. A method using deterministic solution methods for performing radiotherapy dose calculations on acquired image data, the method comprising:
ray-tracing primary photons;
transporting first-scattered-photon and first-scattered electron sources to calculate secondary scattered electron sources;
transporting electron sources to produce an energy-dependent electron flux; and
calculating a dose field.
